(19) United States
(12) Patent Application Publication
(10) Pub. No.: US 2017/0004006 A1
(43) Pub. Date: Jan. 5, 2017

(54) METHOD OF ASSISTING CREATION OF AUTOMATIC EXECUTION SERVICE

(71) Applicant: HITACHI, LTD., Tokyo (JP)

(72) Inventors: Tatsuya MORI, Tokyo (JP); Hirokazu TANIYAMA, Tokyo (JP); Yuta TSURUGA, Tokyo (JP); Norihiro KOBAYASHI, Tokyo (JP); Masashi NAKAOKA, Tokyo (JP)

(21) Appl. No.: 15/120,808

(22) PCT Filed: May 27, 2014
(86) PCT No.: PCT/JP2014/063998

§ 371 Date: Aug. 23, 2016

(51) Int. Cl. G06F 9/48; G06F 9/455; G06F 3/0484; G06F 3/0481; G06F 3/0482

(52) U.S. Cl. CPC G06F 9/4843; G06F 3/04817; G06F 3/0482; G06F 3/0484; G06F 9/45558; G06F 2009/4557

(57) ABSTRACT

Disclosed is a method of assisting creation of an automatic execution service by a management system. The management system displays a plurality of process icons of a plurality of processes included in the automatic execution service on a screen. The management system displays, on the screen, an execution order line, which connects the plurality of process icons and which indicates an execution order of the plurality of processes. The management system displays, on the screen on which the plurality of process icons and the execution order line are displayed, a property reference relation line, which connects the plurality of process icons and which indicates a property reference relation between the plurality of processes.

### BACKGROUND

This invention relates to a method of assisting creation of an automatic execution service.

WO 2013/140609 A1 (Patent Literature 1) is known as a background art of this invention. WO 2013/140609 A1 discloses “A management system stores: level relationship information that indicates a level relationship of multiple operation items that configure an operation flow; execution sequence information that indicates an execution sequence for the multiple operation items; and operation item type information that indicates whether an operation item at the bottom-most level of the operation flow is an automated operation item executed only by a computer, or whether said operation item is a manual execution operation item executed with human intervention during automatic work of the computer. On the basis of the operation item type information and the level relationship information, the management system assesses whether at all lower levels of an operation item of a higher level than the bottom-most level, said operation item contains: one or more automated operation items only; one or more manual execution operation items only; or one or more automated operation items and one or more manual execution operation items. On the basis of the result of said assessment, said management system controls display of icons indicating multiple operation items in a specified level of the operation flow.” (Abstract).

Patent Literature 1: WO 2013/140609 A1

### SUMMARY

In Patent Literature 1, a plurality of operational item icons and arrows indicating an execution order of the operational items are displayed on one screen. However, a user cannot read a flow of data from a display image of Patent Literature 1. Therefore, the display image of Patent Literature 1 has a low visibility when the overall automatic execution service is looked at.

An aspect of this invention is a method of assisting creation of an automatic execution service by a management system, the method, which is executed by the management system, including: displaying a plurality of process icons of a plurality of processes included in the automatic execution service on a screen; displaying, on the screen, an execution order line, which connects the plurality of process icons and which indicates an execution order of the plurality of processes; and displaying, on the screen on which the plurality of process icons and the execution order line are displayed, a property reference relation line, which connects the plurality of process icons and which indicates a property reference relation between the plurality of processes.

According to the one embodiment of this invention, the overall visibility of an automatic execution service in an image for assisting creation of the automatic execution service can be increased.

### BRIEF DESCRIPTION OF THE DRAWINGS

FIG. 1 shows an image example displayed on a screen by the management system according to this embodiment.

FIG. 2 shows a configuration example of the computer system including the management system according to this embodiment.

FIG. 3 shows an image example displayed by the input/output device of the automatic execution service console apparatus.

FIG. 4 shows a method of specifying the execution orders of the processes by the user, and a result of the specified execution orders.

FIG. 5 shows a portion of a property details image.

FIG. 6 shows an image example for receiving a specification of a property reference by the user.

FIG. 7 shows a plurality of property reference relations defined in the image of FIG. 6.

FIG. 8 shows the window displaying a virtual machine cluster configuration service in which all the execution orders and property reference relations are defined.

FIG. 9 shows an image example selectively displaying the property reference relations of the processes selected by the user.

FIG. 10 shows an image example selectively displaying the property reference relation lines of the processes selected by the user in the window showing the property details.

FIG. 11 shows an image example of automatic display of the property reference relations.

FIG. 12 shows a portion of a property details image corresponding to the image illustrated in FIG. 11.

FIG. 13 shows an image example displaying property reference relation lines representing property reference relation candidates.

FIG. 14 shows a configuration example of a service table.

FIG. 15 shows a configuration example of a service property table.

FIG. 16 shows a configuration example of a process class table.

FIG. 17 shows a configuration example of a process class property table.

FIG. 18 shows a configuration example of a process instance table.

FIG. 19 shows a configuration example of an execution order table.

FIG. 20 shows a configuration example of a process instance property table.

FIG. 21 shows a configuration example of a service property reference relation table.

FIG. 22 shows a configuration example of a process property reference relation table.

FIG. 23 shows an overall flowchart of the editing and execution of the automatic execution service.

FIG. 24 shows a flowchart of filtering of the displayed property reference relation lines.

FIG. 25 shows a flowchart of a method of determining the process property reference relations and the process property reference relation candidates of the selected process instances.

FIG. 26 shows a flowchart of another method of determining the process property reference relations and the process property reference relation candidates of the selected process instances.

FIG. 27 shows a flowchart of a method of determining the service property reference relations and the service property reference relation candidates of the selected services.

### DETAILED DESCRIPTION OF THE EMBODIMENTS

An embodiment of this invention is described below with reference to the accompanying drawings. However, it should be noted that the embodiment described below is merely an example for realizing this invention and does not limit a technical scope of this invention. Components common across the respective drawings are denoted by the same reference symbols.

In the following description, although pieces of information of this invention are described by using such expressions as “aaa table”, “aaa list”, “aaa DB”, and “aaa queue”, those pieces of information may be expressed by data structures other than a table, a list, a DB, a queue, and the like. Therefore, “aaa table”, “aaa list”, “aaa DB”, “aaa queue”, and the like are sometimes referred to as “aaa information” in order to show that those pieces of information are independent of their data structures.

In addition, although such expressions as “identification information”, “identifier”, “name”, “ID” are used in order to describe details of each piece of information, those expressions are interchangeable.

In the following description, although a description is given by using “program” as a subject in some cases, the program is executed by a processor to perform defined processing while using a memory and a communication port (communication control device). Therefore, the description given by using “program” as a subject may also be interpreted as a description given by using “processor” as a subject. Further, processing disclosed while a program is used as a subject may also be interpreted as processing performed by a computer, e.g., a management server, or an information processing apparatus. Further, a part or all of a program may also be implemented by dedicated hardware.

Further, various programs may also be installed onto each computer by a program distribution server or computer-readable and non-transitory storage media. The program distribution server in this case includes a processor and storage resources, and the storage resources store a distributing program and programs to be distributed. The processor of the program distribution server executes the distributing program, thereby distributing to other computers the programs to be distributed.

A set of one or more computers configured to manage an information processing system and displaying information for display of the invention of this application is hereinafter sometimes referred to as “management system”. In a case where a management computer displays the information for display, the management computer is the management system. Further, a combination of the management computer and a computer for display is also the management system. Further, processing equivalent to that of the management computer may also be implemented by a plurality of computers in order to speed up management processing and achieve a higher reliability. In this case, the plurality of computers (including the computer for display in a case where the computer for display performs display) are the management system.

As examples of input/output devices of the management system, a display, a keyboard, and a pointer device are conceivable, but the input/output devices may be other devices. Moreover, a serial interface or an Ethernet interface may be used as an input/output device as an alternative to the input/output devices, and input and display on the input/output devices may be substituted by coupling, to the interface, a computer for display including a display, a keyboard, or a pointer device, transmitting information for display to the computer for display, and receiving information for input from the computer for display, thereby performing display on the computer for display and receiving the input from the computer for display.

In this embodiment, editing of an automatic execution service by a user is assisted. The automatic execution service, which is a service that is automatically executed by a computer system, defines procedures for automatically executing a specific task. The computer system is configured to automatically execute a plurality of processes defined in the automatic execution service by using input properties.

The processes, which are constituents of the automatic execution service, are procedure units. Execution orders of the processes included in the automatic execution service are defined. The execution orders define other processes that need to be completed in order for each process to be executed. The execution orders have property reference relations between the automatic execution service to which a process belongs and the other processes. The processes are linked to a command. The computer system is configured to execute the commands linked to the processes during execution of the automatic execution service.

The properties are input values and output values of the service and the processes. The input values are referred to as “input properties” and the output values are referred to as “output properties”. The properties may include elements such as a data type, a name, a value, and an input/output direction. The properties are used as parameters of the commands linked to the processes during execution of the automatic execution service.

The automatic execution service may have one or more input properties and/or one or more output properties. For example, during execution of the automatic execution service, a plurality of input properties may be input to the service, and as a result of execution of the automatic execution service, one output property is output.

One or more input properties and/or one or more output properties may be defined for each process in the automatic execution service. The processes may refer to the output property of another process or the input property of the service as its own input property. The service may refer to an output property of a process as its own output property. Such a relation between the properties is referred to as “property reference relation”.

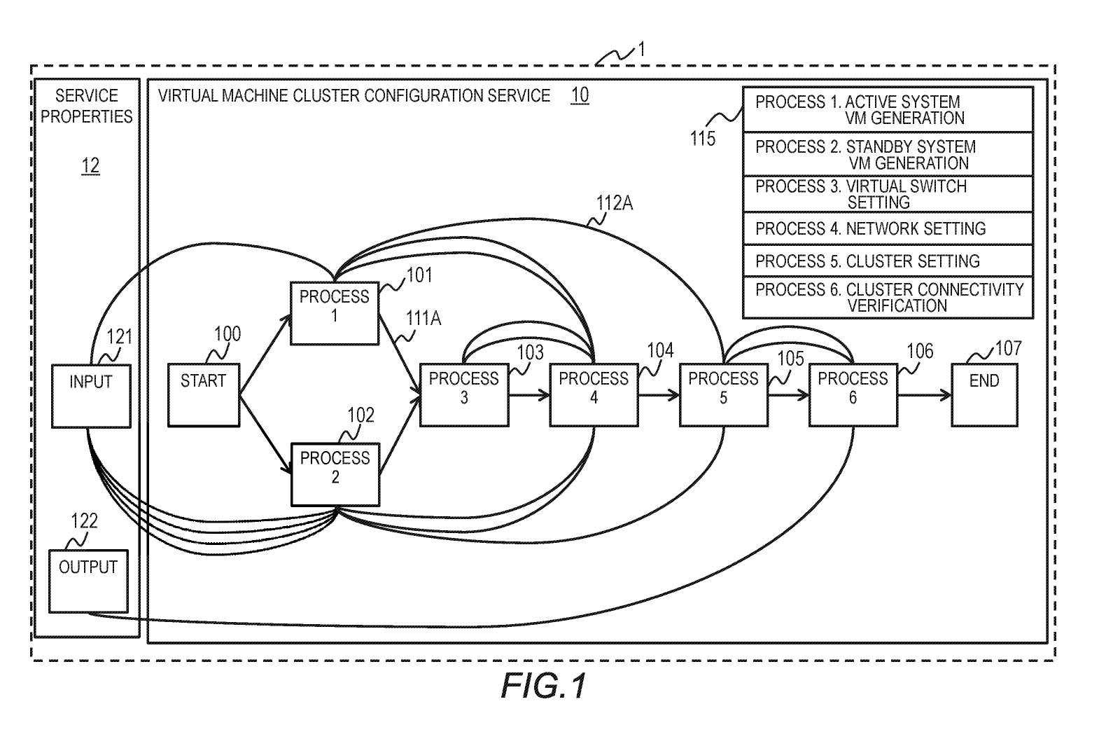

In FIG. 1, an image example displayed on a screen by the management system according to this embodiment is illustrated. The management system is configured to provide a graphical user face (GUI) that allows the user to edit the automatic execution service. A GUI image of this embodiment displays execution order lines indicating an execution order between the processes, and property reference relation lines indicating property reference relations between the processes. Displaying the execution order lines and the property reference relation lines on the same screen enables visibility when the user looks at the overall automatic execution service to be increased.

In the image illustrated in FIG. 1, an example of an editing result of the automatic execution service is displayed. The image shows an example of an automatic execution service (virtual machine cluster configuration service) for creating and setting virtual machines, and for forming a cluster from the created virtual machines.

In FIG. 1, panes 10 and 12 are shown in a window 1. The window 1 and the panes 10 and 12 are all boxes. The pane 10 is configured to display a definition configuration of the virtual machine cluster configuration service. The pane 10 includes icons 101 to 106 of the processes included in the virtual machine cluster configuration service, and icons 100 and 107 indicating a start and an end of the virtual machine cluster configuration service. A box 115 displays a process name of each of processes 1 to 6.

The pane 12 includes icons 121 and 122 representing properties of the virtual machine cluster configuration service. The icon 121 represents the input property and the icon 122 represents the output property.

In the pane 10, the execution orders of the process icons 101 to 106 are indicated by the execution order lines. In this example, the execution order lines are straight arrows connecting the icons. In FIG. 1, one execution order line is denoted by reference numeral 111A, for example. The execution order lines may be defined between the start icon 100 and the process icons, between the process icons, and between the process icons and the end icon 107.

One execution order line connects two icons, and indicates that after the process of the start point of the execution order line has been executed, the process of the end point of the execution order line is executed. One process icon may be the start point of a plurality of execution order lines. One process icon may be the end point of a plurality of execution order lines.

The window 1 is also configured to display lines (property reference relation lines) indicating property reference relations. One property reference relation line is denoted by reference numeral 112A, for example. The property reference relation lines connect two icons having a property reference relation.

The property reference relation lines have an appearance that is visually distinguishable from that of the execution order lines. In the example illustrated in FIG. 1, the execution order lines are straight arrows, and the property reference relation lines are curved lines. In general, there are more property reference relation lines than execution order lines. Drawing the property reference relation lines as curved lines allows many property reference relation lines to be simultaneously displayed on the screen in an easily viewable manner. The execution order lines and the property reference relation lines may have another appearance, as long as the execution order lines and the property reference relation lines are visually distinguishable.

In the example illustrated in FIG. 1, one property reference relation line connects two icons. Specifically, one property reference relation line connects the input icon and one process icon, connects two process icons, or connects one process icon and the output icon.

One property reference relation line indicates a reference relation of one property pair. Specifically, one property reference relation line indicates a reference relation between one input property of the service and one input property of one process, a reference relation between one output property of one process and one input property of one process, or a reference relation between one output property of one process and one output property of the service.

In another example, one property reference relation line may indicate a plurality of property reference relations. For example, when one or more reference relations exist between two icons, all the reference relations between those two icons may be indicated by only one property reference relation line. As a result, the visibility of the display image of the automatic execution service for a service in which many reference relations exist can be increased.

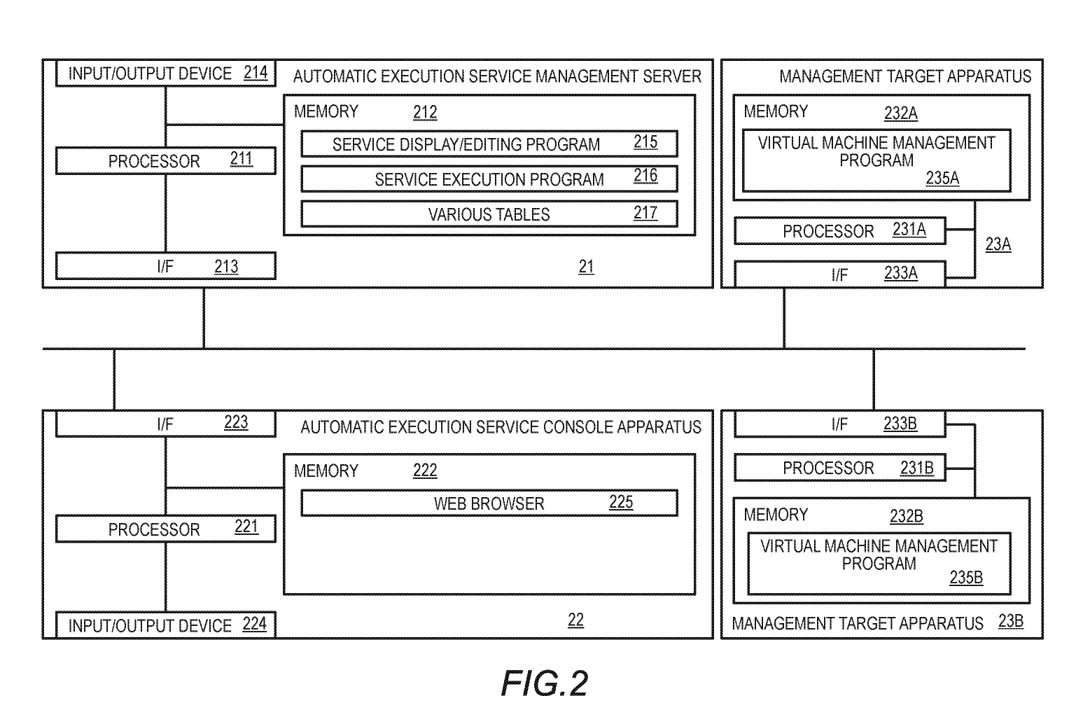

In FIG. 2, a configuration example of the computer system including the management system according to this embodiment, which is configured to assist editing of the automatic execution service, is illustrated. The computer system includes an automatic execution service management server 21, an automatic execution service console apparatus 22, and management target apparatus 23A and 23B, which are coupled to each other via a network.

The management system includes the automatic execution service management server 21 and the automatic execution service console apparatus 22. The management system is configured to manage the management target apparatus 23A and 23B, and to cause the management target apparatus 23A and 23B to execute the automatic execution service edited by the user.

The automatic execution service management server 21 includes a processor 211, a memory 212, a network interface (I/F) 213, and an input/output device 214, which are coupled to each other by a bus.

The input/output device 214 includes a device that allows the user to input information to the automatic execution service management server 21 and a device that allows the automatic execution service management server 21 to output information to the user.

The memory 212 is configured to store, for example, a service display/editing program 215, a service execution program 216, and a table group 217. The memory 212 is also configured to store programs (not shown) that are required for operations performed by the system, including an operating system (OS). The memory 212 may include a volatile memory device and/or a non-volatile memory device.

The processor 211 is configured to implement various functions that are described below by controlling operations of the automatic execution service management server 21 based on the programs, calculation parameters, and the like stored in the memory 212. For example, the processor 211 is configured to operate as a service display/editing module based on the service display/editing program 215. The I/F 213 is a communication interface for communicating to and from another apparatus via the network.

The automatic execution service console apparatus 22 is an interface apparatus between the automatic execution service management server 21 and the user. The user edits the automatic execution service by operating the automatic execution service console apparatus 22.

The automatic execution service console apparatus 22 includes a processor 221, a memory 222, an I/F 223, and an input/output device 224, which are coupled to each other by a bus. The input/output device 224 includes a device that allows the user to input information to the automatic execution service console apparatus 22 and a device that allows the automatic execution service console apparatus 22 to output information to the user. The input device is, for example, a keyboard, a pointing device, a switch, a touch panel, a microphone, and other devices. The output device is, for example, a monitor display, a speaker, a printer, and other devices.

The memory 222 is configured to store, for example, a Web browser 225. The memory 222 is also configured to store programs (not shown) that are required for operations performed by the system, including an OS. The memory 222 may include a volatile memory device and/or a non-volatile memory device. The I/F 223 is a communication interface for communicating to and from another apparatus via the network.

The processor 221 is configured to control operations of the automatic execution service console apparatus 22 based on the programs, calculation parameters, and the like stored in the memory 222. For example, the processor 221, which is operated based on the Web browser 225, is configured to receive user input through the input/output device 224, and to display the GUI image. The processor 221 is configured to communicate information required for editing and execution of the automatic execution service to and from the automatic execution service management server 21 via the I/F 223.

The user inputs an instruction by operating the input/output device 224. The Web browser 225 is configured to transmit the received instruction to the automatic execution service management server 21 via the network. The service display/editing program 215 of the automatic execution service management server 21 is configured to transmit image data in accordance with the instruction from the Web browser 225 to the automatic execution service console apparatus 22.

The Web browser 225 is configured to display on the input/output device 224 an image of the received image data. The automatic execution service console apparatus 22 and the automatic execution service management server 21 are configured to provide to the user the GUI for automatic execution service editing by repeating the operations described above.

The management target apparatus 23A includes a processor 231A, a memory 232A, and an I/F 233A, which are coupled to each other by a bus. The management target apparatus 23B includes a processor 231B, a memory 232B, and an I/F 233B, which are coupled to each other by a bus. A virtual machine management program 235A operates on the management target apparatus 23A, and a virtual machine management program 235B operates on the management target apparatus 23B. The virtual machine management programs 235A and 235B are configured to build and execute a virtual machine cluster based on instructions from the automatic execution service management server 21.

The GUI image of the automatic execution service is now described. The automatic execution service console apparatus 22 is configured to display the GUI image, to receive user input on the GUI image, and to transmit the received user input to the automatic execution service management server 21. The automatic execution service management server 21 is configured to manage the received user input, and to transmit data for the GUI image in accordance with the user input to the automatic execution service console apparatus 22.

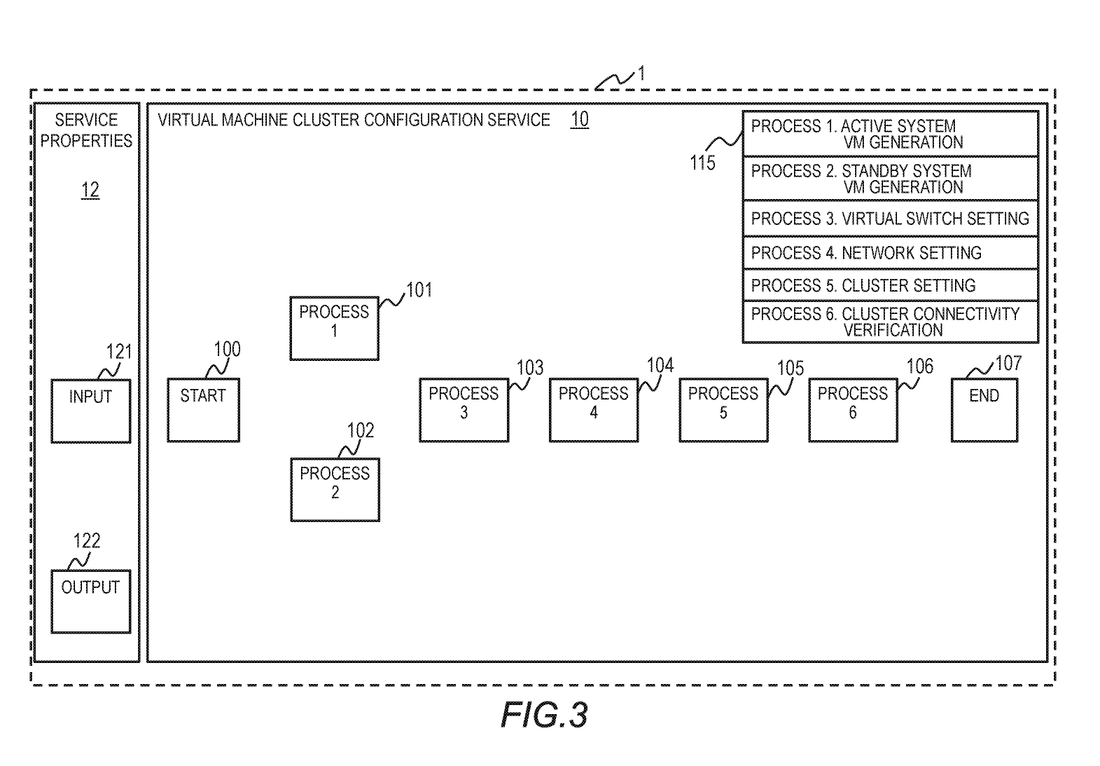

In FIG. 3, an image example displayed by the input/output device 224 of the automatic execution service console apparatus 22 is illustrated. In FIG. 3, an image after the automatic execution service to be newly edited by the user has been specified and the process parts to be used in the editing of the automatic execution service have been selected is illustrated.

The user inputs on an image (not shown) information on the automatic execution service to be newly edited by operating the input/output device 224. The information input to the automatic execution service console apparatus 22 includes a name for identifying the automatic execution service, as well as an input property and an output property. The name of the automatic execution service in this example is “virtual machine cluster configuration service”.

The automatic execution service console apparatus 22 is configured to display, after specification of the automatic execution service, a window 1 and a parts box (not shown). The window 1 is configured to display the input icon 121 and the output icon 122 in the pane 12, and the start icon 100 and the end icon 107 in the pane 10. The input icon 121 and the output icon 122 respectively represent the input property and the output property of the service, which have been input by the user. The process icons 101 to 107 are not yet displayed.

The parts box is configured to display the process icons capable of being included in the automatic execution service. The process icons represent the process parts of the automatic execution service to be edited. The automatic execution service console apparatus 22 is configured to receive a selection of the process icon to be used based on a process icon being dragged from the parts box and dropped into the pane 10.

In the example illustrated in FIG. 3, the process icons 101 to 106 of the processes 1 to 6 are selected, and displayed in the pane 10. The box 115 shows the names of the processes 1 to 6 in the pane 10. The processes 1 to 6 each correspond to a step of the virtual machine cluster configuration service.

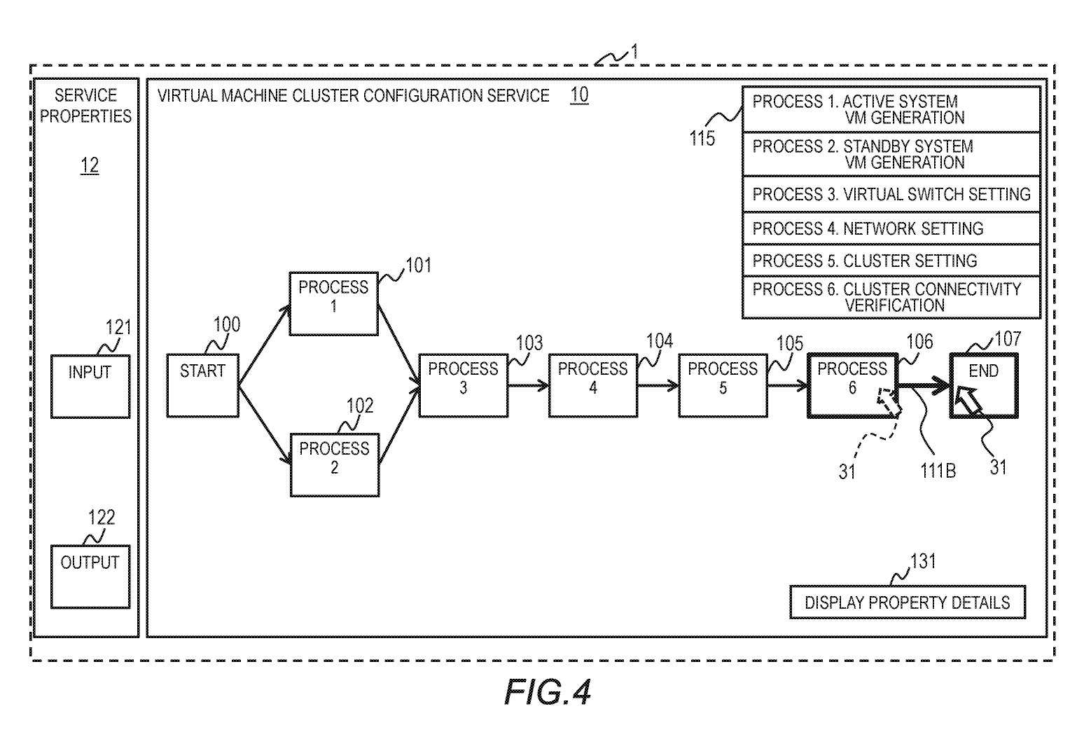

In FIG. 4, a method of specifying the execution orders of the processes 1 to 6 by the user, and a result of the specified execution orders, are illustrated. The execution order of two processes is represented by a straight arrow. The user moves a pointer 31 between the two process icons defining the execution order. The automatic execution service console apparatus 22 is configured to receive the specification of the execution order of the selected start point process icon and the selected end point process icon based on that operation of the pointer 31. In FIG. 4, the process icons 106 and 107 are selected as the start point process icon and the end point process icon, respectively, and the execution order of those process icons is specified.

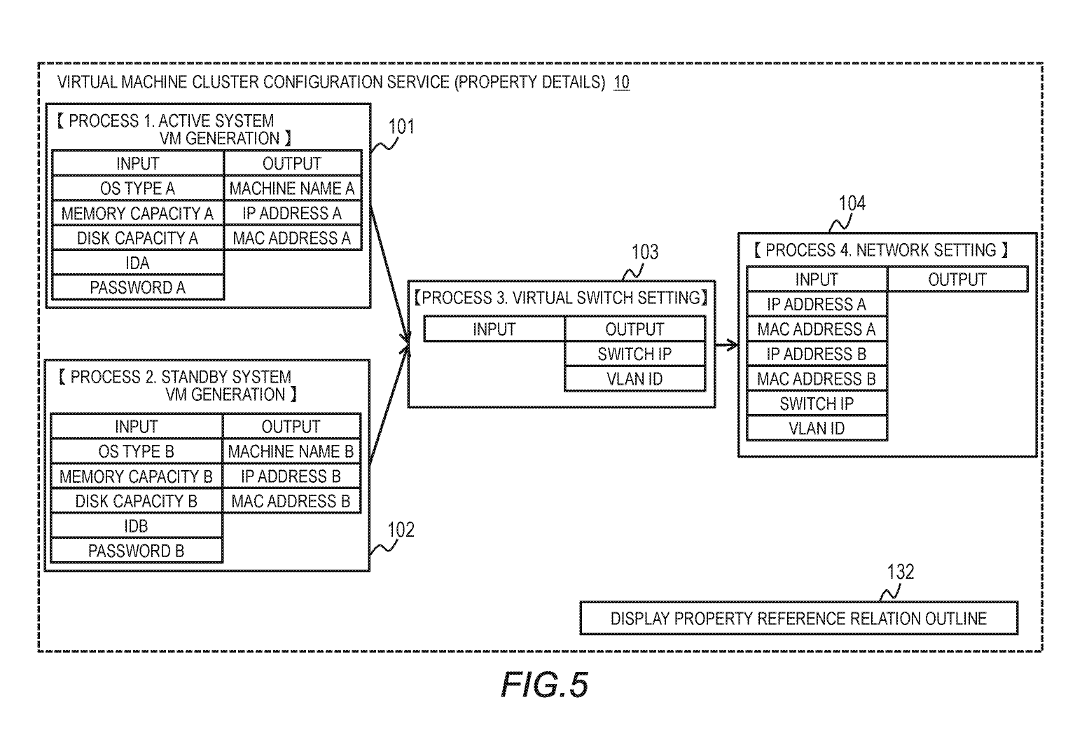

In FIG. 5, a portion of a property details image is illustrated. The automatic execution service console apparatus 22 is configured to display, when a “display property details” button 131 illustrated in FIG. 4 is selected, the details of the properties of the service and the processes. In FIG. 5, the names of the input property and the output property of each of the processes 1 to 4 are shown. The pane 12 is also configured to display the details of the service properties in the same manner. Based on the images of the panes 10 and 12 showing the property details, the user can know the property details of the service and of each process.

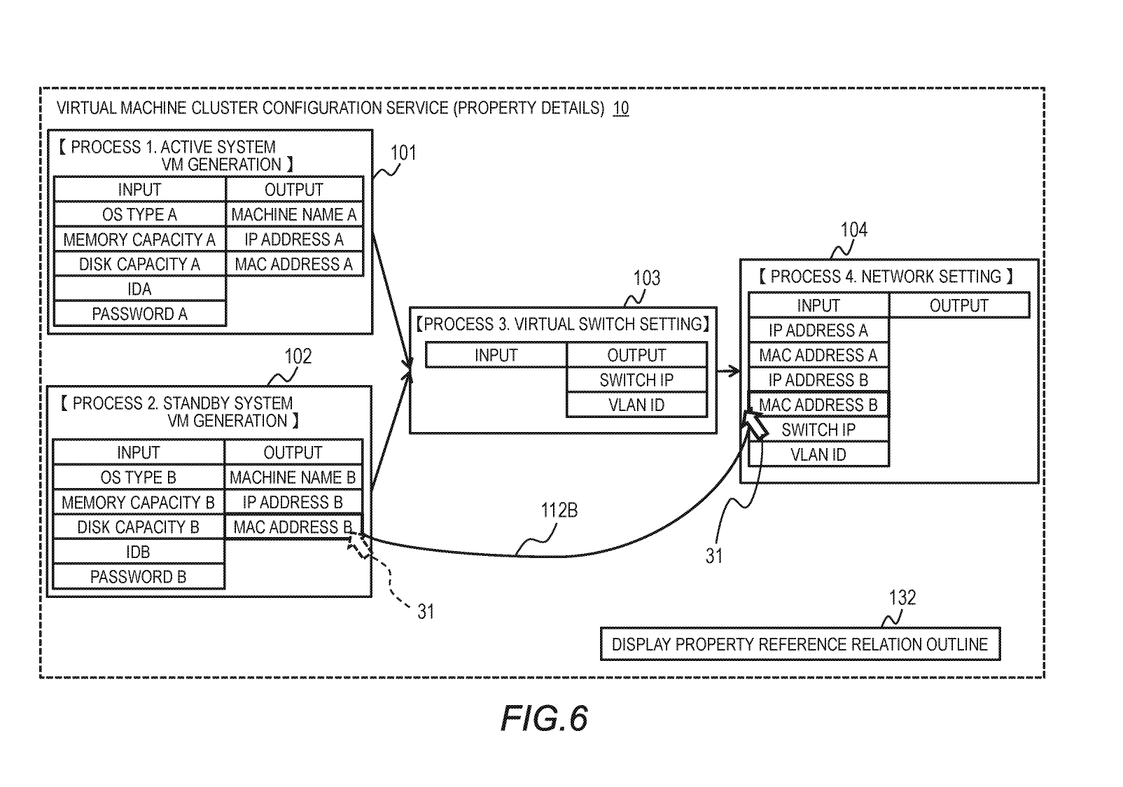

In FIG. 6, an image example for receiving a specification of a property reference by the user is illustrated. The automatic execution service console apparatus 22 is configured to receive a specification by the user of the property reference relation on the image showing the property details. The user moves the pointer 31 between the two properties defining the property reference relation.

The automatic execution service console apparatus 22 is configured to receive the specification of the reference relation between the selected properties based on the operation of the pointer 31. In the example illustrated in FIG. 6, the property reference relation between an output property “MAC address B” of the process 2 and an input property “MAC address B” of the process 4 is defined. A curved line 112B represents that property reference relation.

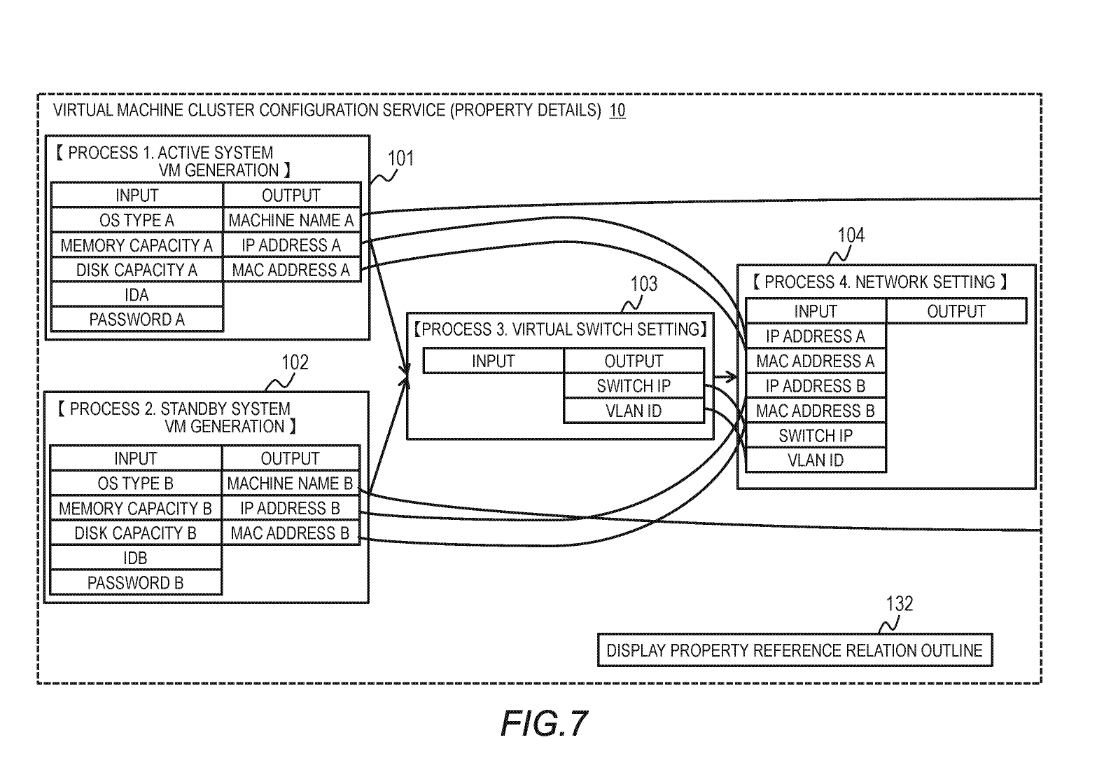

In FIG. 7, a plurality of property reference relations defined in the image of FIG. 6 are illustrated. The automatic execution service console apparatus 22 is configured to repeatedly receive a specification by the user of a reference relation, and to draw curved lines indicating those property reference relations. Each property reference relation line connects (a field of) one input property and (a field of) one output property. The automatic execution service console apparatus 22 is configured to display, when a “display property reference relation outline” button 132 is pressed, an image from which the properties have been omitted, like in the cases illustrated in FIG. 3 and FIG. 4.

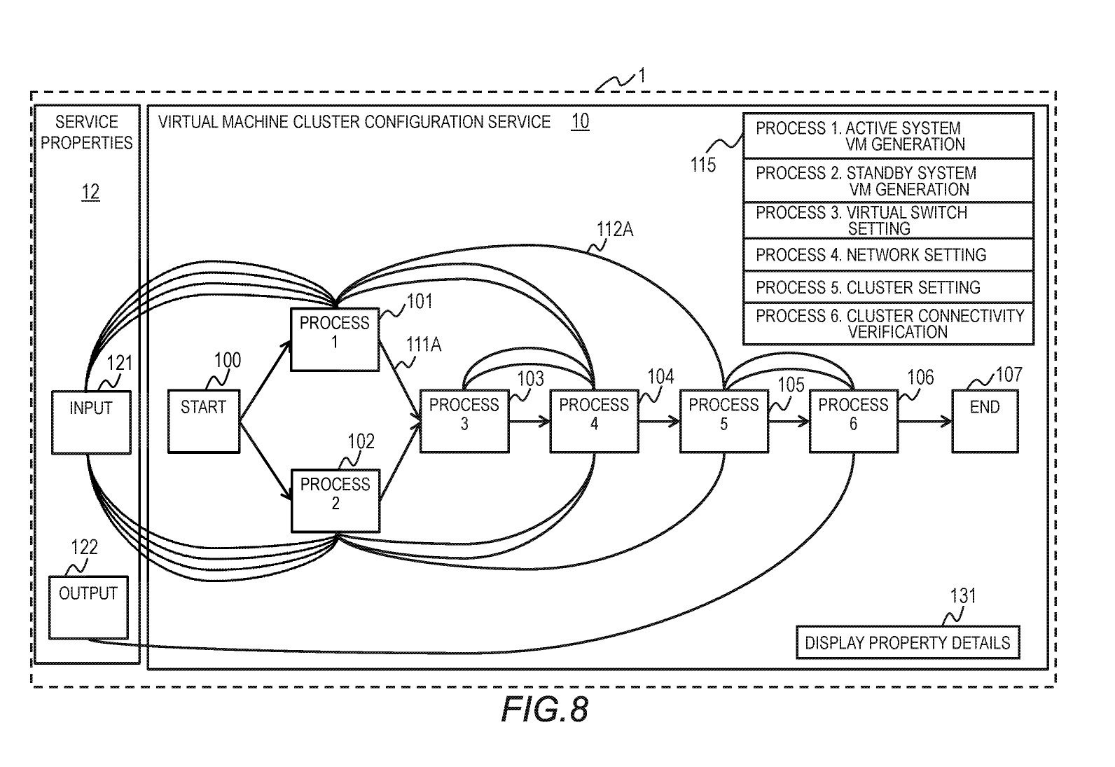

In FIG. 8, the window 1 displaying a virtual machine cluster configuration service in which all the execution orders and property reference relations are defined is illustrated. In FIG. 8, the window 1 from which the property details have been omitted is illustrated. FIG. 8 is the same as FIG. 1, except for the “display property details” button 131. In the example illustrated in FIG. 8, process icons having an earlier execution order are positioned to the left of later process icons.

In FIG. 8, the start points of the straight arrows indicating the execution orders are connected to the start point processes, and the end points are connected to the end point processes. The straight arrows extend from a right side of a rectangular icon to a left side of another rectangular icon. The curved lines indicating the property reference relations are connected to an upper side or a lower side of the rectangular icons. This display method enables the visibility of the execution order lines and the property reference relation lines to be increased.

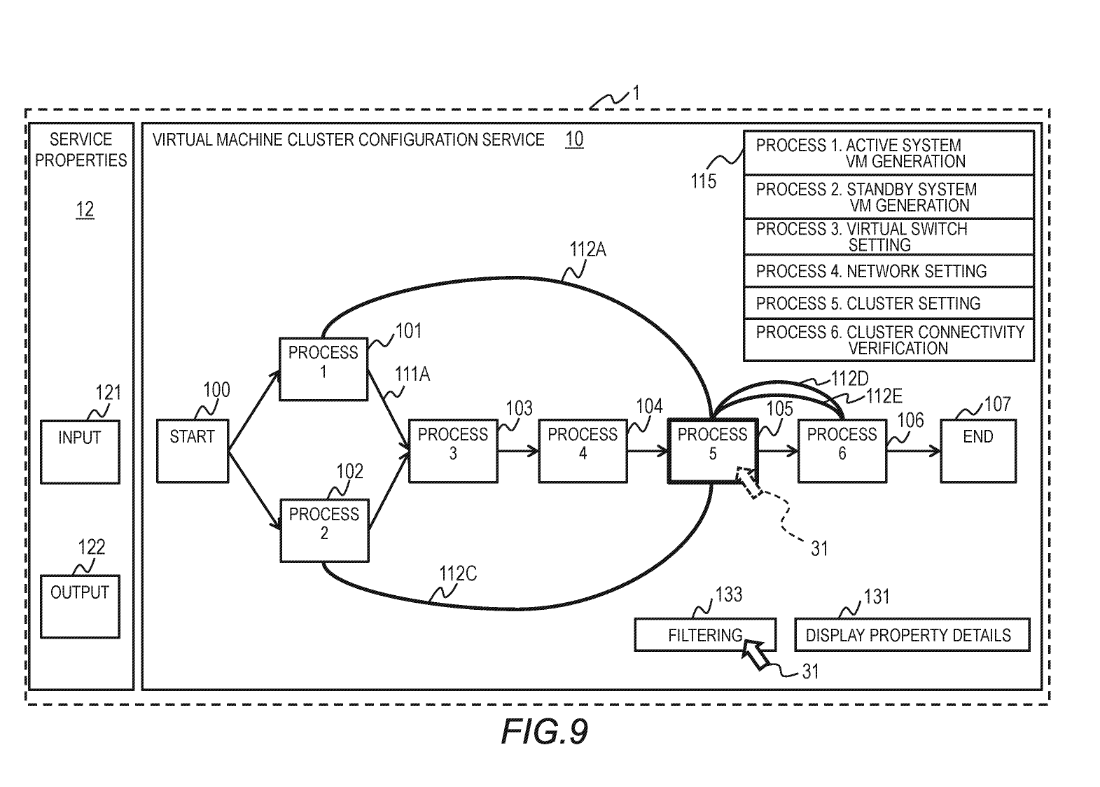

In FIG. 9, an image example selectively displaying the property reference relations of the processes selected by the user is illustrated. In FIG. 9, first, the process icon 105 of the process 5 is selected by the pointer 31, and then a “filtering” button 133 is selected by the pointer 31. The window 1 is configured to display, among all the property reference relations, only property reference relations 112A and 112C including the input property of the process 5 and property reference relations 112D and 112E including the output property of the process 5.

Selectively displaying the property reference relation lines of the processes selected by the user enables, from among a large number of property reference relation lines, only the property reference relation lines required by the user to be displayed with increased visibility.

When the “display property details” button 131 is selected, the property details of the property reference relations 112A and 112C and the property details of the property reference relations 112D and 112E including the output property are displayed.

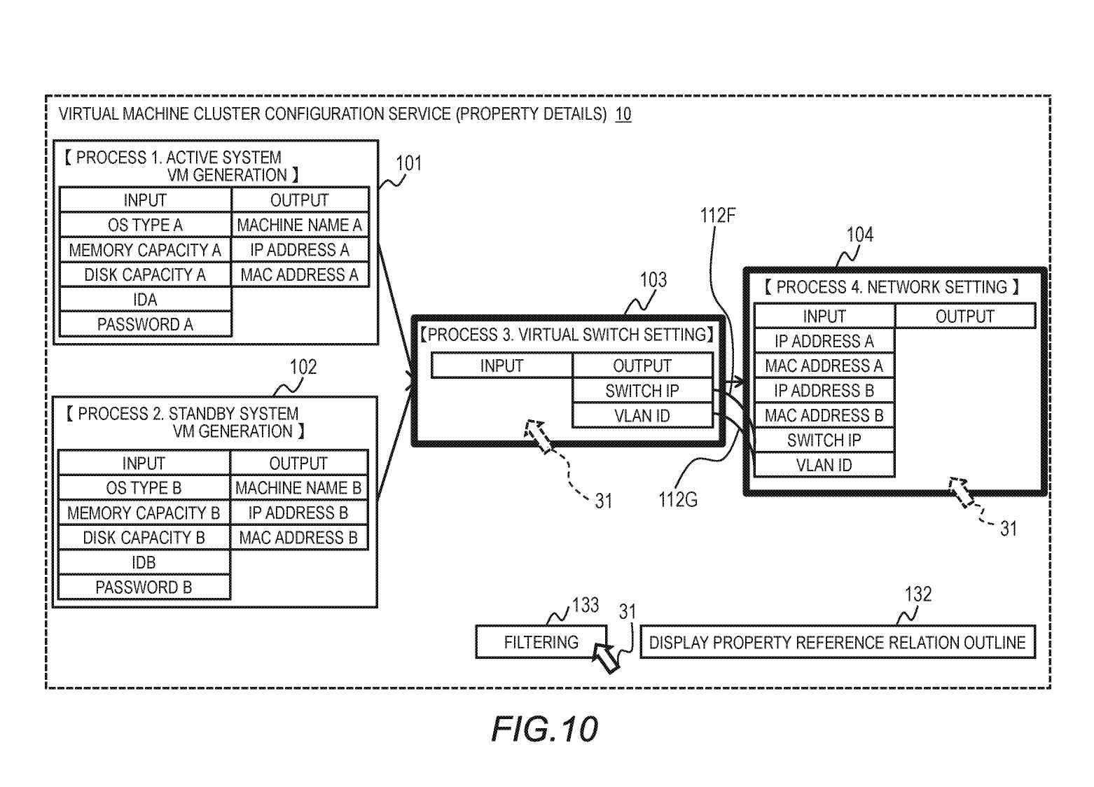

In FIG. 9, all of the execution order lines are illustrated. However, the execution order lines relating to the selected processes, namely, the execution order lines that are the start point or the end point of the selected processes, may be selectively displayed. When two process icons have been selected, the property reference relation lines including the properties of those two process icons may be selectively displayed, or the property reference relation lines including the properties of at least one of the two process icons may be displayed. This point is also the same in the description of FIG. 10.

In FIG. 10, an image example selectively displaying the property reference relation lines of the processes selected by the user in the window 1 showing the property details is illustrated. In FIG. 10, the specific properties of the selected property reference relation lines can be verified.

In FIG. 10, the process icons 103 and 104 of the processes 3 and 4 are simultaneously selected. The window 1 selectively displays property reference relation lines 112F and 112G relating to both the processes 3 and 4. In other words, the output property of each of the displayed property reference relation lines 112F and 112G is the output property of the process 3, and the input property of each of the displayed property reference relation lines 112F and 112G is the input property of the process 4.

In the example described above, the property reference relation lines relating to the selected processes are selectively displayed. However, as a different embodiment, the management system may also be configured to selectively display the property reference relation lines of selected properties. For example, the management system may be configured to display only the property reference relation lines of properties having a selected data type or property name.

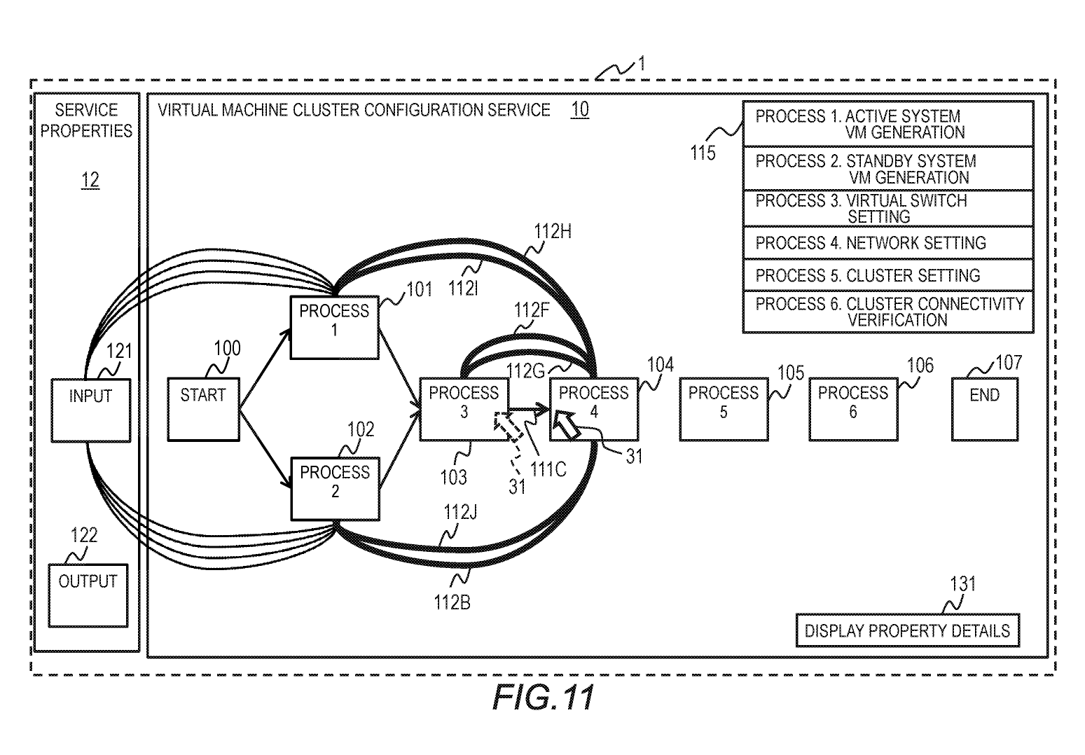

In FIG. 11, an image example of automatic display of the property reference relations is illustrated. The automatic execution service management server 21 is configured to determine the property reference relations between the process parts based on an execution order specified by the user, and to display the property reference relation lines of those property reference relations. As a result, an editing time of the automatic execution service can be shortened.

In FIG. 11, an execution order between the process 3 and the process 4 is newly defined by the user. The execution order is represented by an execution order line 111C. The automatic execution service management server 21 is configured to determine the reference relations of the input property of the process 4, which is an end point process, based on the already defined execution order and other properties. The automatic execution service management server 21 is configured to generate image data including the property reference relations of the determined property reference relations, and to transmit the generated image data to the automatic execution service console apparatus 22.

As illustrated in FIG. 11, the automatic execution service console apparatus 22 is configured to display in the window 1 the property reference relation lines 112B, 112G, 112F, and 112H to 112J, which include the input property of the process 4. The automatic execution service console apparatus 22 is configured to display, when the “display property details” button 131 is selected, the specific properties of the process parts.

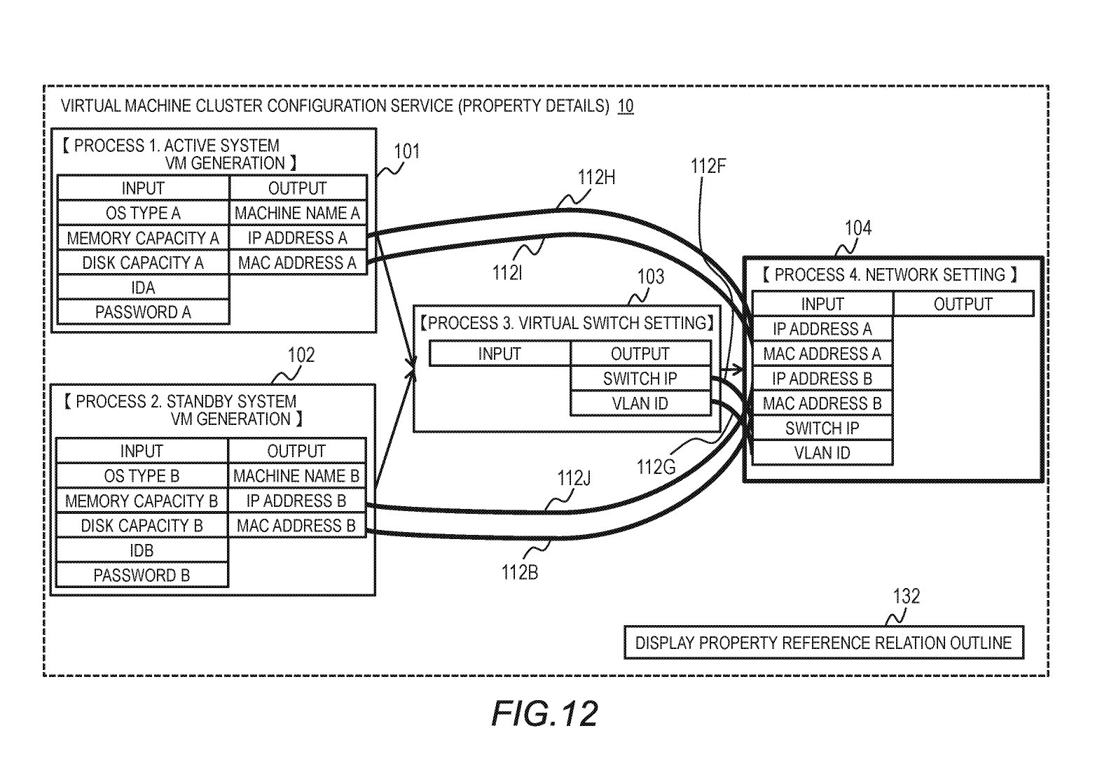

In FIG. 12, a portion of a property details image corresponding to the image illustrated in FIG. 11 is illustrated. Further, in FIG. 12, the newly determined property reference relation lines of the process 4 are also illustrated. Each of the property reference relation lines 112B, 112G, 112F, and 112H to 112J of the input property of the process 4 are displayed together with the property names of the processes 1 to 4. Similar to FIG. 7, the property reference relation lines connect an input property name and an output property name. The property details image enables the specific content of the property reference relations to be verified.

In the examples illustrated in FIG. 11 and FIG. 12, property reference relations uniquely determined for the input property of the selected process are displayed. When a plurality of property reference relation candidates exist for one input property, in the above-mentioned example, the property reference relation candidates are not displayed. The management system is configured to register the property reference relations specified for the input property based on a pointer operation by the user as the property reference relations of that input property.

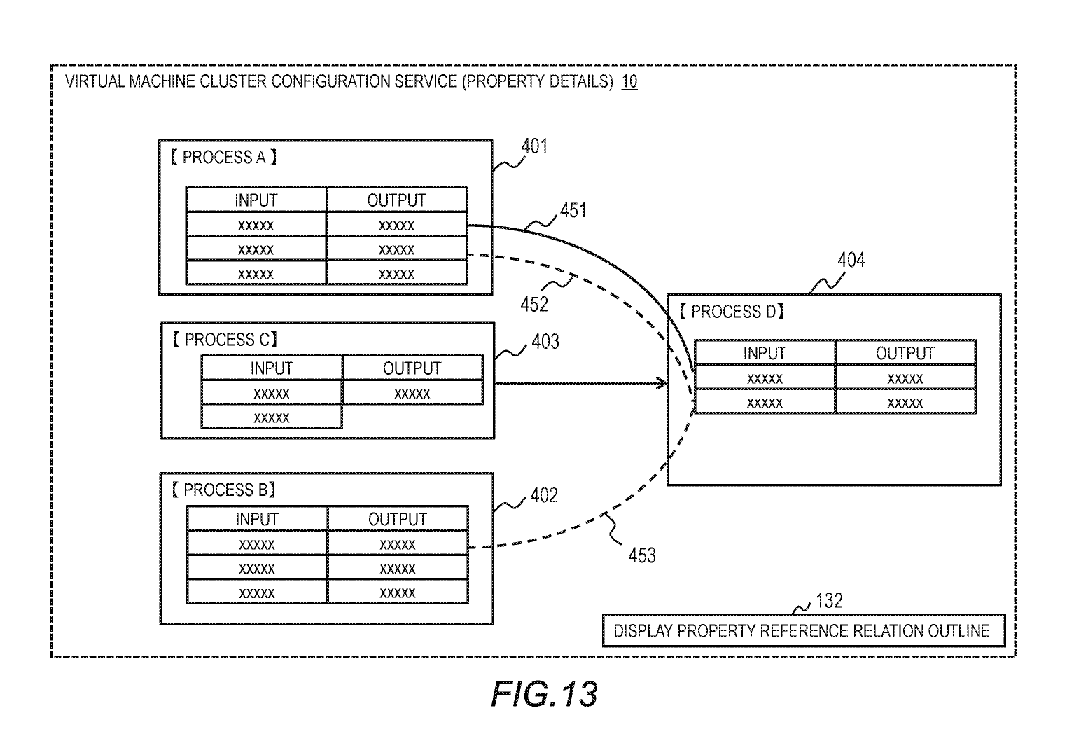

The automatic execution service management server 21 may be configured to generate, when a plurality of property reference relation candidates exist for the input property, image data representing the plurality of property reference relation candidates. In FIG. 13, an image example displaying property reference relation lines representing property reference relation candidates is illustrated.

The processes A to D are respectively represented by process icons 401 to 404. The pane 10 is configured to display the property details of each process. The automatic execution service management server 21 is configured to determine, when the process D is the newly selected process, the property reference relations of the input property of the process D.

A property reference relation line 451 indicates a property reference relation uniquely determined for the input property of the process 4. Property reference relation lines 452 and 453 indicate property reference relation candidates for one input property of the process 4. The unique property reference relations are represented as solid lines, and undetermined property reference relation candidates are represented as dotted lines.

The automatic execution service management server 21 is configured to determine and register, when any one of the property reference relation lines 452 and 453 is selected by the user, the selected property reference relation candidate as a property reference relation of the input property. Displaying the property reference relation candidates enables the time taken by the user to determine the property reference relations to be shortened.

It is not necessary to represent the property reference relation candidates and the unique property reference relations by using solid lines and dotted lines, as long as the lines of the property reference relation candidates and the lines of the unique property reference relations have an appearance that allows those lines to be distinguished. The property reference relation candidates may be indicated by using image elements different from lines. For example, the automatic execution service console apparatus 22 may be configured to display in a box a list showing the start point property and the end point property of the property reference relation candidates.

In the above-mentioned example, the property reference relations of the input property of the end point process are automatically determined in response to the user specifying the execution order. The management system may be configured to receive the selection of the process after a plurality of execution orders, for example, all the execution orders, have been determined, and to automatically determine the property reference relations including the properties of that process. The management system may also be configured to determine, in addition to the property reference relations of the input property, the property reference relations of the output property of the selected process.

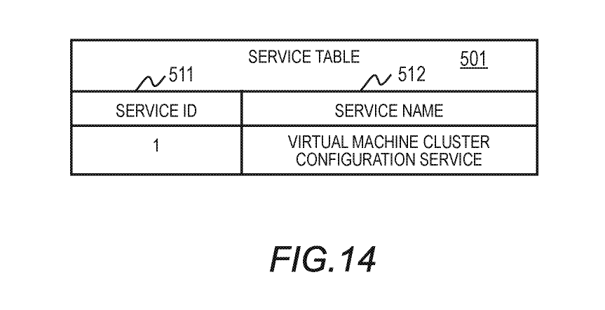

Tables included in the table group 217 are now described. In FIG. 14, a configuration example of a service table 501 is shown. The service table 501 is for managing the automatic execution service, which is specified by the user and which is to be edited by the management system based on user input. In the service table 501, a relation is shown between a service identification (ID) 511 and a service name 512 of the automatic execution service.

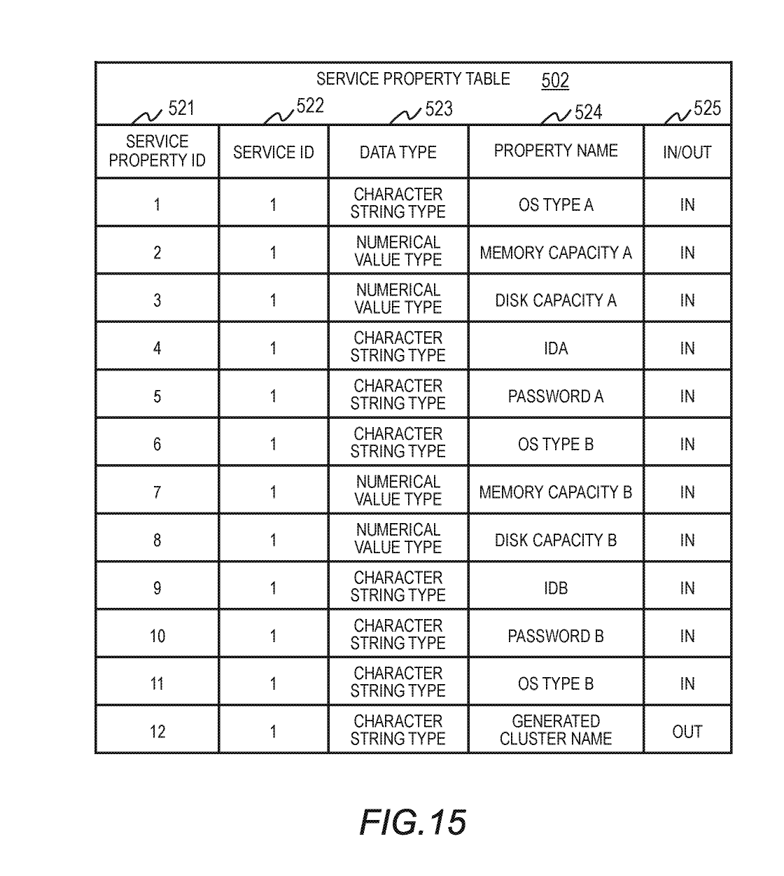

In FIG. 15, a configuration example of a service property table 502 is shown. The service property table 502 is for managing the input property and the output property of the automatic execution service. In the service property table 502, a service property ID 521, a service ID 522, a data type 523, a property name 524, and a property IN/OUT 525 of each service property are shown.

The service properties are input by the user. The service ID 522 shows the service ID of the service to which the service properties belong. The property IN/OUT 525 shows whether or not the service property is an input property or an output property.

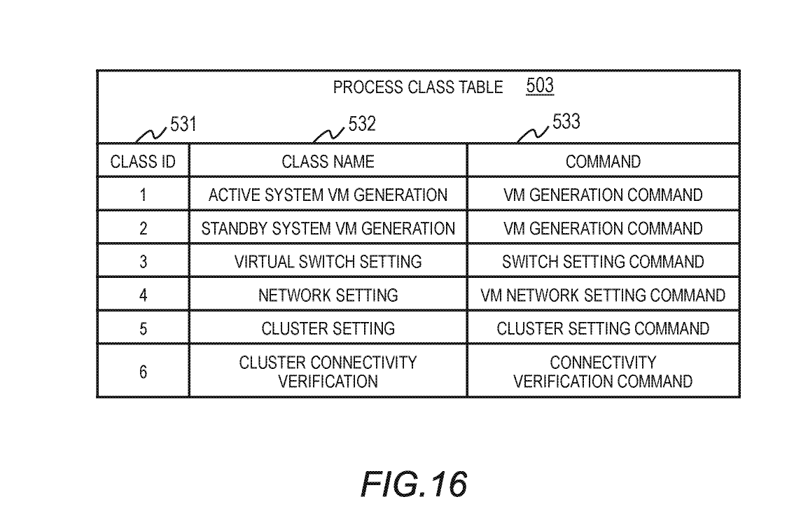

In FIG. 16, a configuration example of a process class table 503 is shown. The process class table 503 is for managing process classes, which are prepared in advance and which are capable of being used in the automatic execution service. The user selects a process class for generating a process instance to be included in the automatic execution service from the process classes in the process class table 503. In the process class table 503, a class ID 531, a class name 532, and a command 533 of each process class are shown.

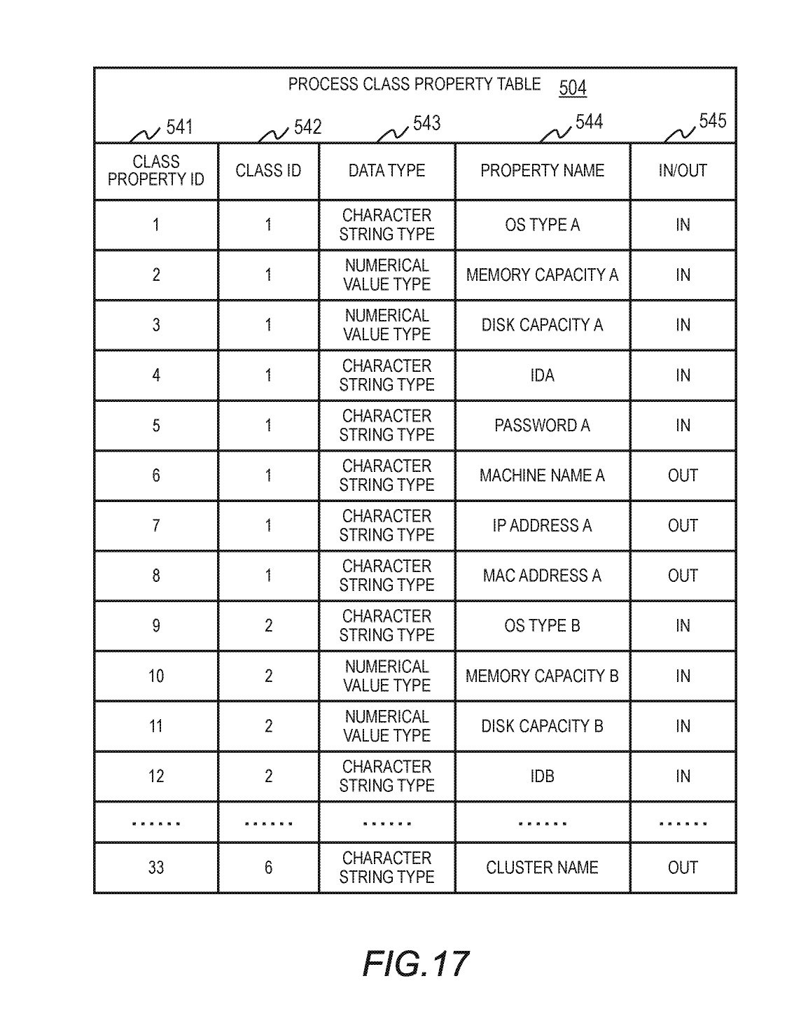

In FIG. 17, a configuration example of a process class property table 504 is shown. The process class property table 504 is for managing properties of process classes, which are prepared in advance. In the process class property table 504, a class property ID 541, a class ID 542, a data type 543, a property name 544, and a property IN/OUT 545 of each process class property are shown.

The class ID 542 shows the class ID of the class to which the class properties belong. The property IN/OUT 545 shows whether or not the class property is an input property or an output property.

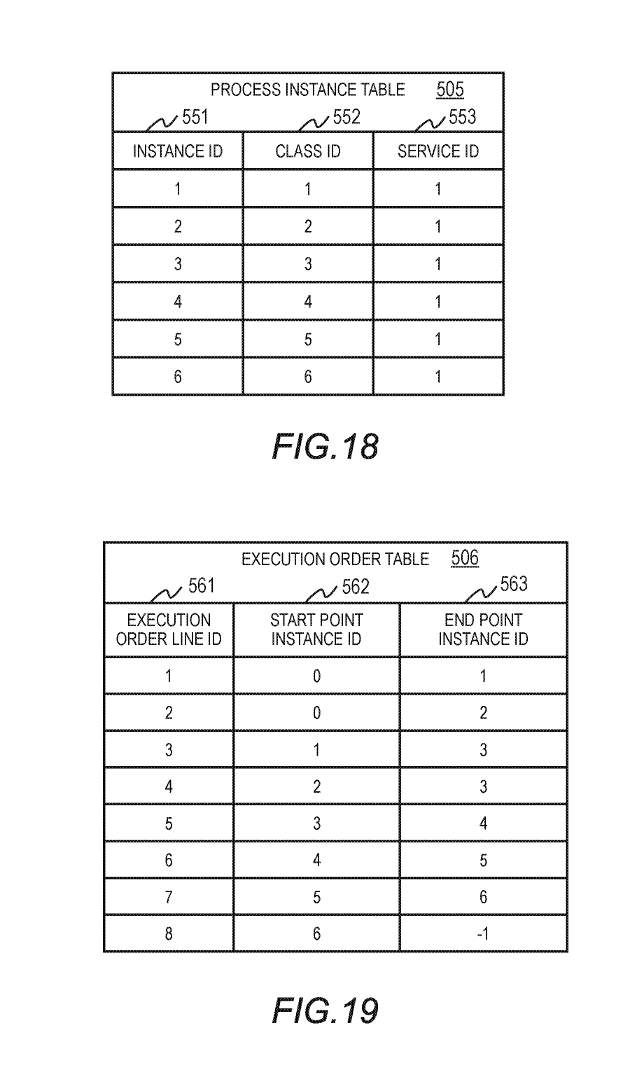

In FIG. 18, a configuration example of a process instance table 505 is shown. The process instance table 505 is for managing the process class instances selected by the user as the constituents of the automatic execution service.

In the process instance table 505, an instance ID 551, a class ID 552, and a service ID 553 of each process instance are shown. The class ID 552 shows the class ID of the process class generated by the process instance. The service ID 553 shows the service ID of the automatic execution service to which the process instance belongs.

In FIG. 19, a configuration example of an execution order table 506 is shown. The execution order table 506 is for managing the execution orders (execution order lines) of the processes (process instances) defined in the automatic execution service. The execution order table 506 is updated, for example, each time one execution order line is defined. In the execution order table 506, an execution order line ID 561, a start point instance ID 562, and an end point instance ID 563 of each execution order line are shown.

It is not necessary for the order of the numbers of the execution order line ID 561 to match the execution order of the processes. The start point instance ID 562 is the instance ID of the start point process instance of the execution order lines. The end point instance ID 563 is the instance ID of the end point process instance of the execution order lines.

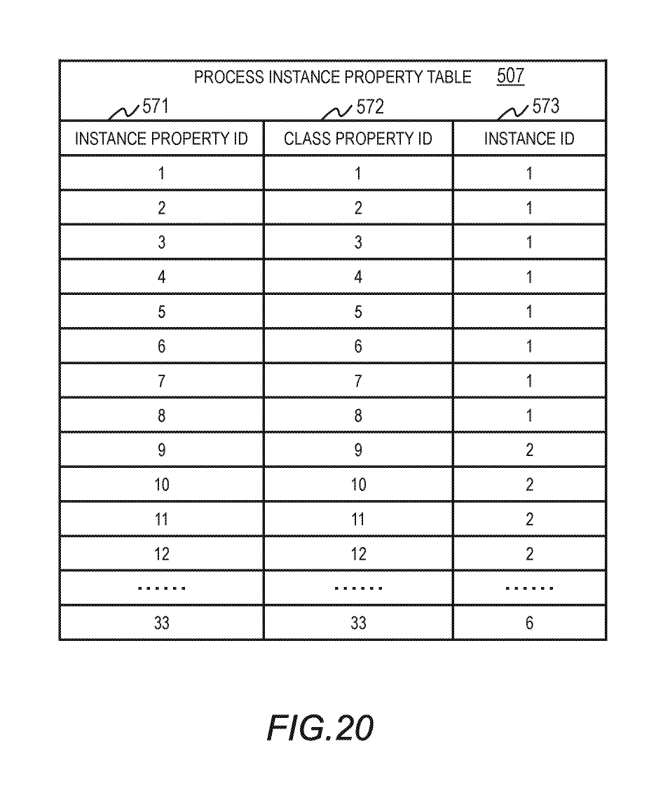

In FIG. 20, a configuration example of a process instance property table 507 is shown. The process instance property table 507 is for managing the properties of the process instances. In the process instance property table 507, an instance property ID 571, a class property ID 572, and an instance ID 573 of each process instance property are shown.

The class property ID 572 shows the class property ID of a class property generated by a process instance property. The instance ID 573 shows the instance ID of a process instance including a process instance property.

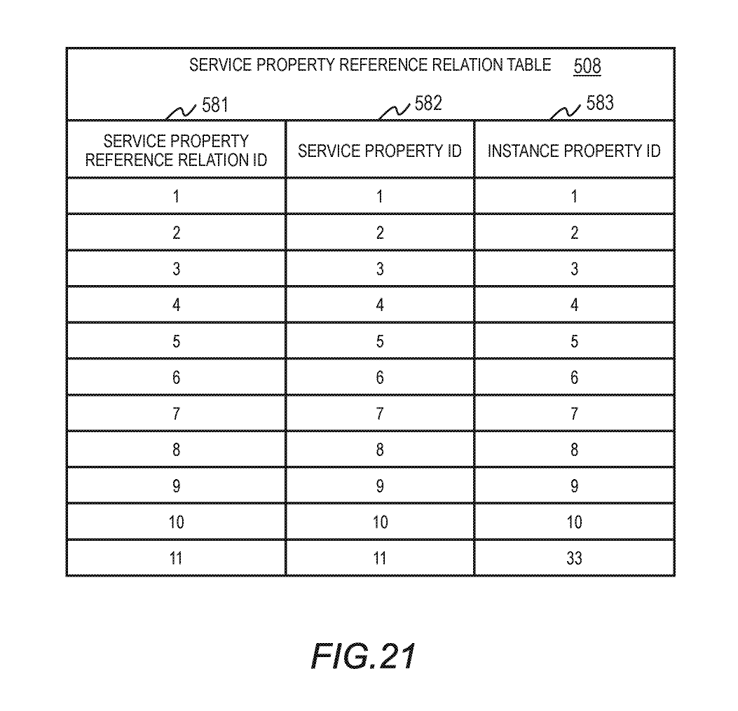

In FIG. 21, a configuration example of a service property reference relation table 508 is shown. The service property reference relation table 508 is for managing the property reference relations including a service property. In the service property reference relation table 508, a service property reference relation ID 581, a service property ID 582, and an instance property ID 583 of each service property reference relation are shown. The service property ID 582 shows the service property ID of a service property included in a property reference relation. The instance property ID 583 shows the process property ID of the process properties included in the property reference relation.

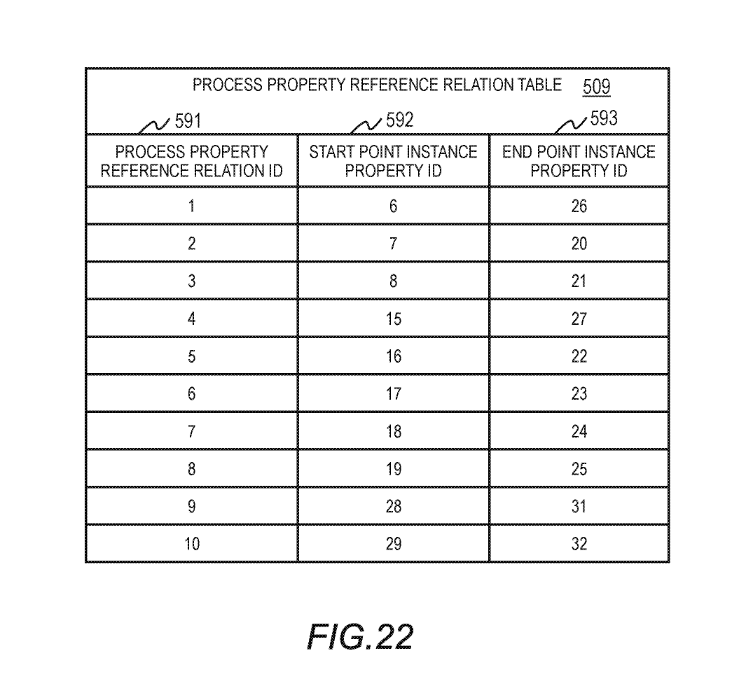

In FIG. 22, a configuration example of a process property reference relation table 509 is shown. The process property reference relation table 509 is for managing the process property reference relations among the process properties. In the process property reference relation table 509, a process property reference relation ID 591, a start point instance property ID 592, and an end point instance property ID 593 of each process property reference relation are shown.

The start point instance property ID 592 shows the instance property ID of the start point process instance property of a property reference relation. The end point instance property ID 593 shows the instance property ID of the end point process instance property of a property reference relation.

Among the information stored in the table group 217 of the automatic execution service management server 21, the IDs corresponding to image elements, such as the icons on the GUI image, the execution order lines, and the property reference relation lines, are shared by the automatic execution service console apparatus 22. Examples of the shared IDs include the service ID 511, the service property ID 521, the instance ID 505, the instance property ID 571, the service property reference relation ID 581, the process property reference relation ID 591, and the execution order line ID 561.

The automatic execution service management server 21 and the automatic execution service console apparatus 22 may be configured to share the IDs of the image elements, and the automatic execution service console apparatus 22 may be configured to transmit the IDs of image elements selected by the user to the automatic execution service management server 21. The automatic execution service management server 21 is configured to store information for managing an association relation between the image element IDs and the IDs in the table group 217, and to refer to that information to determine from any one of the image element IDs and the IDs in the table group 217 another of the image element IDs and the IDs in the table group 217.

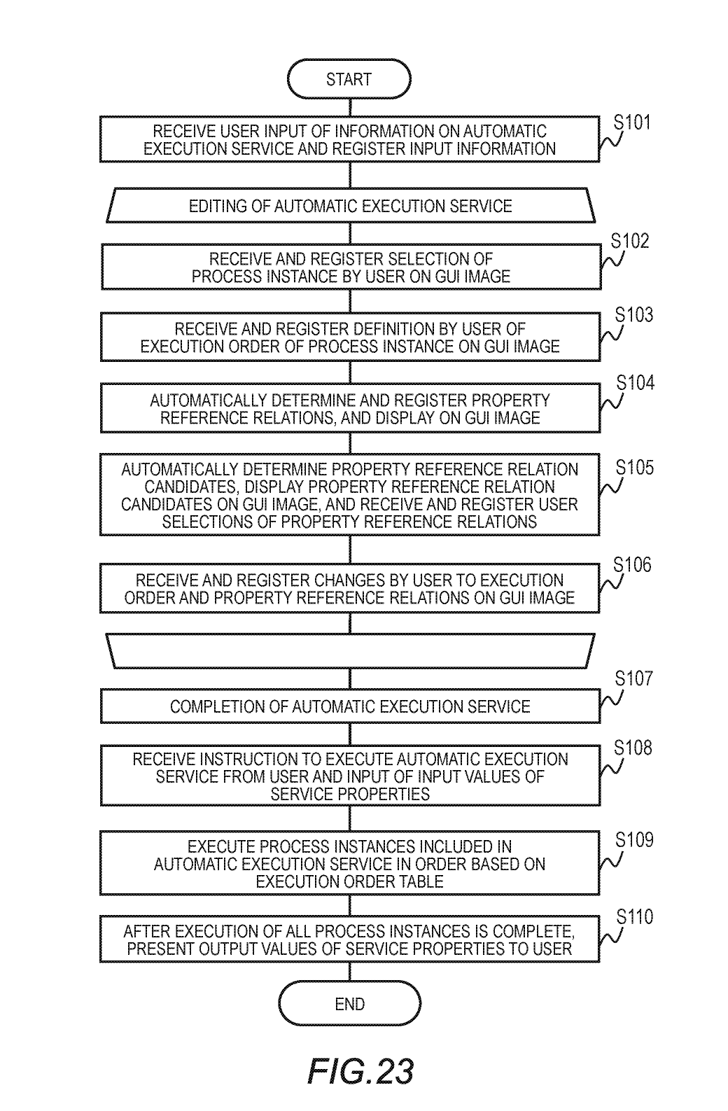

In FIG. 23, an overall flowchart of the editing and execution of the automatic execution service is illustrated. In Step S101, in the automatic execution service console apparatus 22, the Web browser 225 receives user input of information on the automatic execution service, and transmits the received user input to the automatic execution service management server 21. The information on the automatic execution service contains the service name and the service properties. The service display/editing program 215 stores the received information on the automatic execution service in the service table 501 and the service property table 502.

After the information on the automatic execution service has been acquired, the automatic execution service console apparatus 22 and the automatic execution service management server 21 edit the automatic execution service based on user input that is input via the GUI. Steps S102 to S106 are steps that may be executed during editing of the automatic execution service. The same step may be repeatedly executed. The execution order of those steps is not fixed.

In Step S102, the Web browser 225 receives a selection of a process instance by the user on the GUI image based on the image data received from the automatic execution service management server 21. As described with reference to FIG. 3, the Web browser 225 receives the user selection of the process instance based on movement of the process icon from a process parts box (not shown) to the pane 10. In the process parts box, icons of the process classes stored in the process class table 503 and the process class property table 504 are displayed.

The Web browser 225 transmits information on the selected process instance to the automatic execution service management server 21. The service display/editing program 215 stores the information on the selected process instance in the process instance table 505 and the process instance property table 507.

In Step S103, the Web browser 225 receives on the GUI image a definition by the user of the execution order of the process instance. As described with reference to FIG. 4, the Web browser 225 receives the user input of the execution order line between two process icons based on the selection of those two process icons. The Web browser 225 then transmits information on the newly defined execution order line to the automatic execution service management server 21.

The transmitted information contains the instance IDs of the start point process icon and the end point process icon. The service display/editing program 215 adds a new entry to the execution order table 506. Specifically, the service display/editing program 215 stores the newly defined execution order line ID, the received process instance, and the received end point instance ID.

In Step S104, the service display/editing program 215 automatically determines the property reference relations of the selected process instance, and stores that information in the service property reference relation table 508 or the process property reference relation table 509. The details of the automatic determination of the property reference relations are described later. The service display/editing program 215 transmits image data including the property reference relation lines representing the determined property reference relations to the automatic execution service console apparatus 22. The Web browser 225 displays an image of that image data.

In Step S105, the service display/editing program 215 automatically determines the property reference relation candidates. The details of the automatic determination of the property reference relation candidates are described later. The service display/editing program 215 transmits image data including the property reference relation lines (property reference relation candidate lines) representing the determined property reference relation candidates to the automatic execution service console apparatus 22. The Web browser 225 displays an image of that image data.

The Web browser 225 receives a selection of one property reference relation candidate line, and transmits the property IDs of the start point and the end point of that property reference relation candidate line to the automatic execution service management server 21. When the selected property reference relation candidate line represents a service property reference relation, the transmitted property IDs are the service property ID and the instance property ID. When the selected property reference relation candidate line represents a process property reference relation, the transmitted property IDs are the start point instance property ID and the end point instance property ID.

The service display/editing program 215 stores information on the selected property reference relation candidate as the defined property reference relation in the service property reference relation table 508 or the process property reference relation table 509. Steps S104 and S105 may be omitted.

In Step S106, the Web browser 225 receives on the GUI image changes by the user to the execution orders and the property reference relations. The Web browser 225 then transmits the information input by the user to the automatic execution service management server 21. The service display/editing program 215 updates the table group 217 based on the received information.

For example, the Web browser 225 receives a change that deletes an execution order line or a property reference relation line selected by the user. The Web browser 225 deletes the selected line from the window 1 in descending order, and then transmits the ID of that line to the automatic execution service management server 21. The Web browser 225 also deletes from the table group 217 information on the line specified by the ID.

The Web browser 225 receives a change to an execution order line or a property reference relation line. For example, the Web browser 225 receives a change to a start point process icon or an end point process icon of an execution order line. The Web browser 225 changes the start point or the end point of the execution order line on the window 1 and transmits the changed information to the automatic execution service management server 21. The service display/editing program 215 then updates the information of the entry of the changed execution order line in the execution order table 506.

Similarly, the Web browser 225 receives a change to a start point property or an end point property of a property reference relation line. The Web browser 225 changes the start point property or the end point property of the property reference relation line on the window 1, and transmits the changed information to the automatic execution service management server 21.

The service display/editing program 215 updates the information of the entry of the changed property reference relation line in the service property reference relation table 508 or the process property reference relation table 509. When it is determined that a change destination of a start point property or an end point property of a property reference relation line is prohibited, the Web browser 225 or the service display/editing program 215 does not receive the change. This point is the same for the execution order lines.

As described with reference to FIG. 6 and FIG. 7, the management system receives a definition of a new property reference relation by the user via the input/output device 224. The Web browser 225 receives the user input of the property reference relation line between two properties based on the selection of those two properties. The Web browser 225 then transmits information on the newly defined property reference relation line to the automatic execution service management server 21.

When a service property reference relation is to be newly defined, the transmitted information includes the service property ID and the instance property ID. When a process reference relation is to be newly defined, the transmitted information includes the start point instance property ID and the end point instance property ID. The service display/editing program 215 adds the new entry to the service property reference relation table 508 or the process property reference relation table 509.

Specifically, when a service property reference relation is to be newly defined, the service display/editing program 215 stores the newly defined service property reference relation ID, the received service property ID, and the received instance ID. When a process property reference relation is to be newly defined, the service display/editing program 215 stores the newly defined process property reference relation ID, the start point instance property ID, and the end point instance property ID.

After the automatic execution service has been completed in Step S107, in Step S108, the Web browser 225 receives input of an instruction to execute the automatic execution service and service property input values from the user, and transmits the received input to the automatic execution service management server 21.

In Step S109, the service execution program 216 issues, when the instruction to execute the automatic execution service is received from the user, an instruction to the management target apparatus 23A and 23B to execute that service.

The service execution program 216 issues an instruction to the management target apparatus 23A and 23B to execute the process instances included in the automatic execution service based on the execution orders registered in the execution order table 506. The service execution program 216 also transmits the service property input values acquired from the user, the information in the service property reference relation table 508, and the information in the process property reference relation table 509 to the management target apparatus 23A and 23B.

In Step S110, after execution of all the process instances is complete, the service execution program 216 transmits the output values of the service properties received from the management target apparatus 23A and 23B to the automatic execution service console apparatus 22. The Web browser 225 presents the received output values to the user on an image.

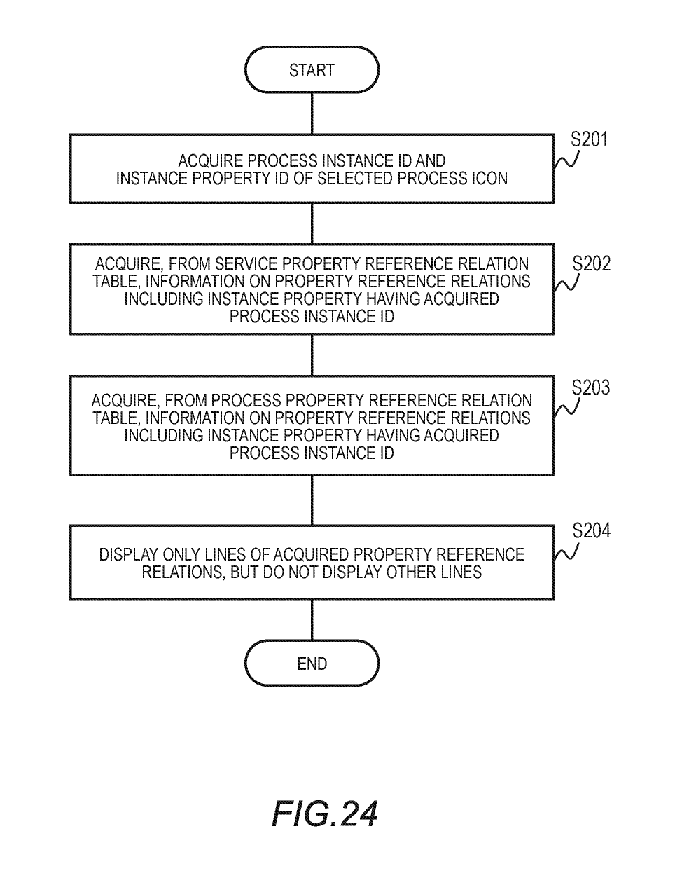

In FIG. 24, a flowchart of filtering of the displayed property reference relation lines is illustrated. As described with reference to FIG. 9 and FIG. 10, the management system selectively displays the property reference relation lines of the properties included in the process instance selected by the user. The filtering is capable of being executed during any of Steps S102 to S106 of the automatic execution service editing in the flowchart illustrated in FIG. 23.

In Step S201, the service display/editing program 215 acquires from the automatic execution service console apparatus 22 the process instance ID of one process icon selected by the user. The service display/editing program 215 acquires from the process instance property table 507 the instance property ID of the acquired process instance ID.

In Step S202, the service display/editing program 215 acquires from the service property reference relation table 508 information on the property reference relations including the acquired instance property ID.

In Step S203, the service display/editing program 215 acquires from the process property reference relation table 509 information on the property reference relations including the acquired instance property ID.

In Step S204, the service display/editing program 215 displays only the property reference relation lines of the property reference relations for which information was acquired in Steps S202 and S203, generates non-display image data for the other property reference relation lines, and transmits the generated non-display image data to the automatic execution service console apparatus 22. The Web browser 225 displays an image based on the received image data.

In Step S203, the service display/editing program 215 may also select only the property reference relation lines of the immediately previous and/or immediately following process instance of the specified process instance.

The service display/editing program 215 refers to the execution order table 506, and identifies the immediately previous and/or immediately following process instance of the process instance selected by the user. The service display/editing program 215 refers to the process instance property table 507, and identifies the instance properties included in the immediately previous and/or immediately following process instance. The service display/editing program 215 then selects, from among the property reference relations acquired from the process property reference relation table 509, the property reference relations including those identified process instance properties.

As in the example described above with reference to FIG. 10, during the filtering of the property reference relation lines, the management system may receive selections of a plurality of elements from the service input property, the service output property, and the plurality of process instances. The service display/editing program 215 displays only the property reference relation lines formed from the properties of the selected elements. Both of the two properties of the displayed property reference relation lines are included in any one of the selected elements.

The service display/editing program 215 refers to the service property table 502 and identifies the selected service properties. The service display/editing program 215 refers to the process instance property table 507 and identifies the process instance properties of the selected process instances.

The service display/editing program 215 then refers to the service property reference relation table 508 and the process property reference relation table 509, and identifies the property reference relations formed from the properties included in the identified service properties and process instance properties. The service display/editing program 215 generates image data displaying only the property reference relation lines of the identified property reference relations.

The service display/editing program 215 may also execute the filtering of the property reference relation lines based on the property instances. For example, the service display/editing program 215 may execute filtering based on the data type. The service display/editing program 215 receives from the automatic execution service console apparatus 22 the data type selected by the user.

The service display/editing program 215 refers to the process instance property table 507 and the process class property table 504, and identifies the process instance properties of the selected data type. The service display/editing program 215 then refers to the service property reference relation table 508 and the process property reference relation table 509, and identifies the property reference relations including the identified process instance properties.

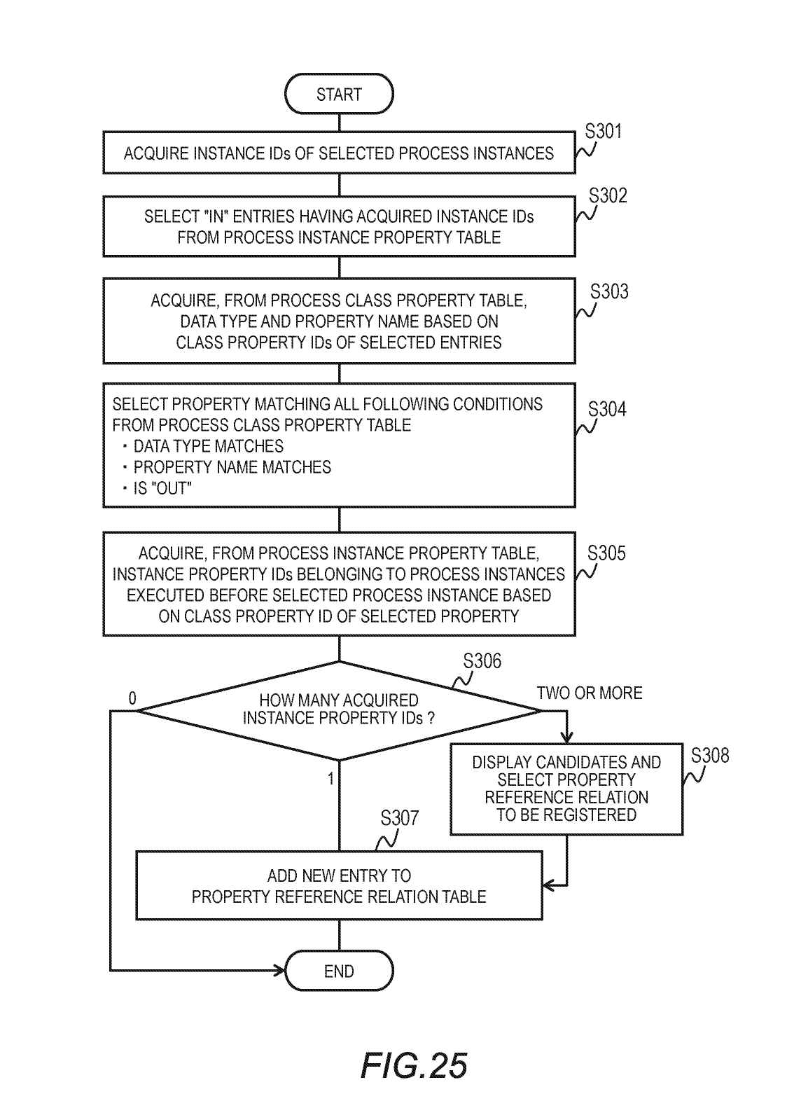

In FIG. 25, a flowchart of a method of determining the process property reference relations and the process property reference relation candidates of the selected process instances is illustrated. The process instances may be selected, for example, during the definition of one execution order line, or after all the execution order lines have been defined. In the flowchart illustrated in FIG. 25, the property reference relations and the property reference relation candidates of the input properties of the process instances are determined.

In Step S301, the service display/editing program 215 acquires from the automatic execution service console apparatus 22 the instance IDs of the selected process instances.

In Step S302, the service display/editing program 215 selects from the process instance property table 507 the IN entries, namely, the input instance properties, having the acquired instance IDs.

Specifically, the service display/editing program 215 selects from the process instance property table 507 the entries having the acquired instance IDs. Further, based on the class property IDs of the selected entries, the service display/editing program 215 acquires information on the IN/OUT 545 of the selected entries from the process class property table 504, and selects the IN entries.

In Step S303, based on the class property IDs of the selected entries, the service display/editing program 215 acquires from the process class property table 504 a data type 543 and a property name 544.

The service display/editing program 215 executes Steps S304 to S307 on each of the entries (input instance properties) selected in Step S302.

In Step S304, the service display/editing program 215 selects from the process class property table 504 an entry (class property) matching all of the following conditions. More specifically, those conditions are that the property matches an input instance property selected in Step S302 and the data type and the property name acquired in Step S303, and that IN/OUT is OUT, namely, the property is an output property.

In Step S305, the service display/editing program 215 refers to the execution order table 506, and identifies the process instances executed before the selected process instance. Further, based on the class property ID of the entry (property) selected in Step S304, the service display/editing program 215 acquires from the process instance property table 507 the instance property IDs belonging to the process instances executed before the selected process instance.

When the number of instance property IDs acquired in Step S305 is zero (S306: 0), the service display/editing program 215 finishes this processing flow. When the number of instance property IDs acquired in Step S305 is one (S306: 1), the service display/editing program 215 advances the processing to Step S307.

In Step S307, the service display/editing program 215 adds a new entry to the service property reference relation table 508 or the process property reference relation table 509.

When the number of instance property IDs acquired in Step S305 is two or more (S306: 2 or more), the service display/editing program 215 advances the processing to Step S307 via Step S308.

In Step S308, the service display/editing program 215 generates image data displaying the property reference relation candidates formed from the selected input instance properties and from the acquired two or more output instance properties, and transmits the generated image data to the automatic execution service console apparatus 22.

The Web browser 225 displays a GUI image showing the plurality of property reference relation candidates based on the received image data, and receives a selection of one property reference relation by the user. The service display/editing program 215 receives from the Web browser 225 information on the property reference relation selected by the user.

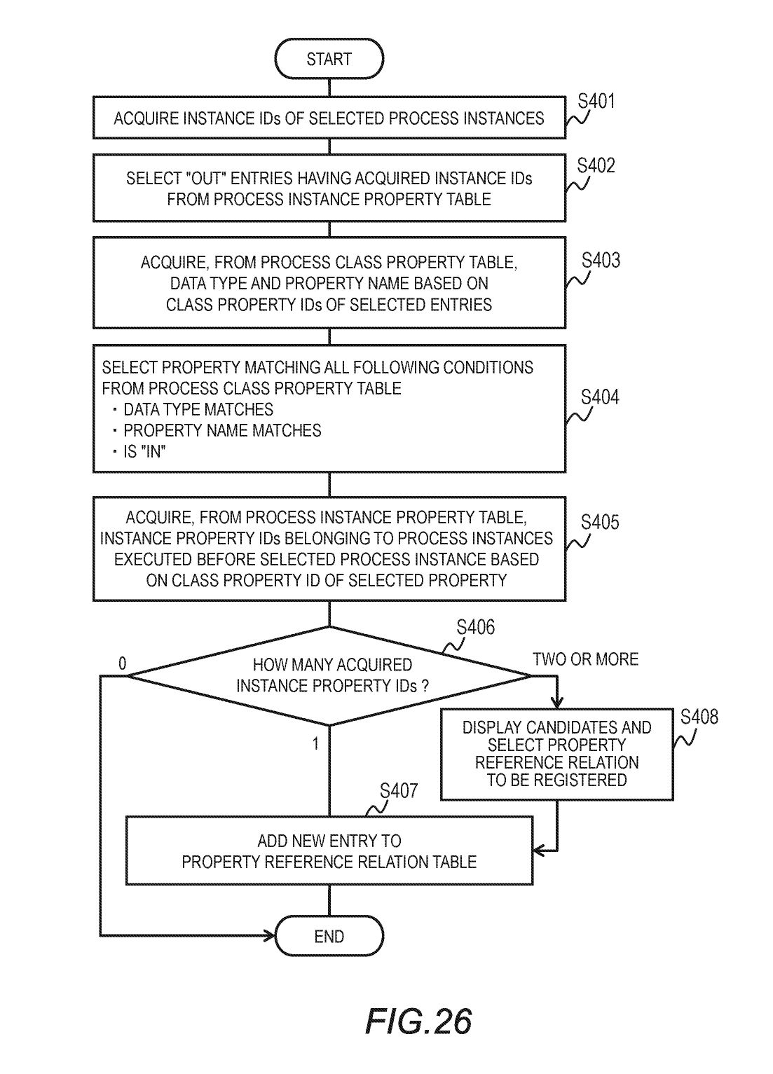

In FIG. 26, a flowchart of another method of determining the process property reference relations and the process property reference relation candidates of the selected process instances is illustrated. In the flowchart illustrated in FIG. 26, the property reference relations and the property reference relation candidates of the output properties of the process instances are determined.

Differences from the flowchart illustrated in FIG. 25 are mainly described. The service display/editing program 215 identifies the output instance property of the selected process instance (S402). The service display/editing program 215 executes Steps S404 to S407 on each of the entries (output instance properties) selected in Step S402.

In Step S404, the service display/editing program 215 selects from the process class property table 504 an entry (class property) matching all of the following conditions. More specifically, those conditions are that the property matches an output instance property selected in Step S402 and the data type and the property name acquired in Step S403, and that IN/OUT is IN, namely, the property is an input property.

The other steps are roughly the same as those in the flowchart of FIG. 25, and hence a description thereof is omitted here. However, in Step S404, the input instance properties for which another property reference relation has already been defined in the service property reference relation table 508 or the process property reference relation table 509 may be excluded from the candidates.

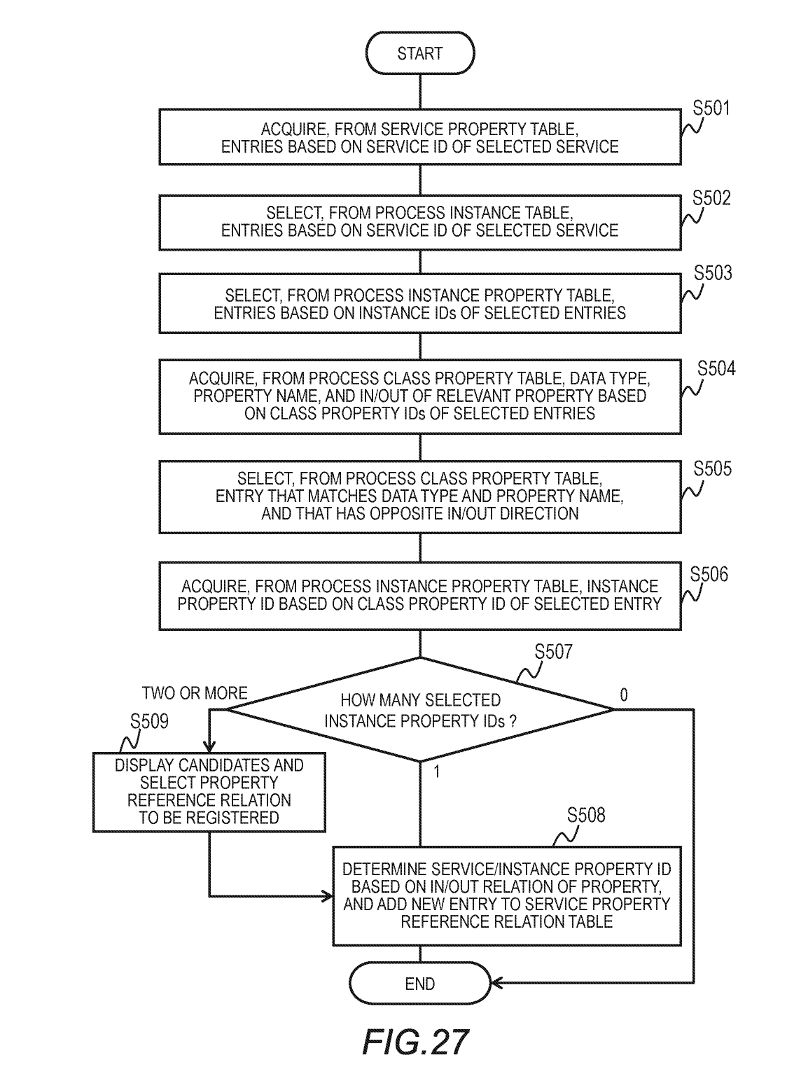

In FIG. 27, a flowchart of a method of determining the service property reference relations and the service property reference relation candidates of the selected services is illustrated. In this case, a method of automatically determining the service property reference relations and the service property reference relation candidates after all the execution order lines have been defined is described.

In Step S501, the service display/editing program 215 acquires from the automatic execution service console apparatus 22 the service ID of the service selected by the user, and based on that service ID, acquires entries from the service property table 502.

In Step S502, based on the service ID of the selected service, the service display/editing program 215 selects entries from the process instance table 505.

In Step S503, based on the instance IDs of the entries selected in Step S502, the service display/editing program 215 selects entries from the process instance property table 507.

In Step S504, based on the class property IDs of the entries selected in Step S503, the service display/editing program 215 acquires from the process class property table 504 a data type, a property name, and IN/OUT.

The service display/editing program 215 executes Steps S505 to S509 on each of the entries (service properties) selected in Step S501.

In Step S505, the service display/editing program 215 selects from the process class property table 504 an entry having a selected service property that matches the data type and the property name, and that has the opposite IN/OUT direction.

In Step S506, based on the class property ID of the entry selected in Step S505, the service display/editing program 215 acquires the instance property IDs from the process instance property table 507.

When the number of instance property IDs acquired in Step S506 is zero (S507: 0), the service display/editing program 215 finishes this processing flow. When the number of instance property IDs acquired in Step S506 is one (S507: 1), the service display/editing program 215 advances the processing to Step S508. When the number of instance property IDs acquired in Step S506 is two or more (S507: 2 or more), the service display/editing program 215 advances the processing to Step S508 via Step S509.

In Step S508, the service display/editing program 215 determines the service property ID/instance property ID based on the IN/OUT relation of the property, and adds a new entry to the service property reference relation table 508.

In Step S509, the service display/editing program 215 generates image data displaying the property reference relation candidates formed from the selected service properties and from the acquired two or more instance properties, and transmits the generated image data to the automatic execution service console apparatus 22.

As the method of determining the service property reference relations and the service property reference relation candidates of the selected process instances, for example, in Step S304 of FIG. 25, a property having an input instance property that matches the data type and the property name, and for which IN/OUT is IN, namely, is an input property, may be further selected from the service property table 502. Further, in Step S404 of FIG. 26, a property having an output instance property that matches the data type and the property name, and for which IN/OUT is OUT, namely, is an output property, may be further selected from the service property table 502.

As described above, in this embodiment, displaying the execution order lines and the property reference relation lines of the processes on the same window enables the visibility of the configuration of the automatic execution service being edited and the task efficiency of the user to be increased. Because the execution order lines are straight lines and the property reference relation lines are curved lines, the visibility of an automatic execution service configuration diagram that requires many property reference relation lines can be improved. In this embodiment, the visibility of a configuration image of the automatic execution service, which tends to be complicated, can be improved based on a filtering function of the property reference relation lines.

In this embodiment, when properties for which the property reference relations are capable of being estimated can be determined in pairs, the property reference relations are automatically set. As a result, a task load on the user is reduced, and the efficiency of service creation can be increased. When there are a plurality of service property reference relation candidates, those candidates are presented to the user, the user selects one of the candidates, and the property reference relations are set between the selected properties. As a result, the task load on the user is reduced, and the efficiency of service creation can be increased.

For example, the embodiment has described this invention in detail for the ease of understanding, and this invention is not necessarily limited to a mode that includes all of the configurations described above. A part of the configuration of one embodiment may be replaced with the configuration of another embodiment. The configuration of one embodiment may be used in combination with the configuration of another embodiment. In each embodiment, another configuration may be added to, deleted from, or replace a part of the configuration of the embodiment.

The components, functions, and processing modules, and the like described above may be implemented partially or entirely by hardware by, for example, designing the components and the like as an integrated circuit. The components, functions, and the like described above may also be implemented by using software by interpreting and executing, with a processor, programs that implement the respective functions.

The programs, tables, files, and other types of information for implementing the functions can be put on a recording device, e.g., a memory, a hard disk drive, or a solid state drive (SSD), or on a recording medium, e.g., an IC card or an SD card.

What is claimed is:

1. A method of assisting creation of an automatic execution service by a management system, the method, which is executed by the management system, comprising:
displaying a plurality of process icons of a plurality of processes included in the automatic execution service on a screen;
displaying, on the screen, an execution order line, which connects the plurality of process icons and which indicates an execution order of the plurality of processes; and
displaying, on the screen on which the plurality of process icons and the execution order line are displayed, a property reference relation line, which connects the plurality of process icons and which indicates a property reference relation between the plurality of processes.

2. The method according to claim 1, wherein the property reference relation line comprises a curved line.

3. The method according to claim 1, the method, which is executed by the management system, further comprising:
receiving a user specification of the property reference relation;
selecting the property reference relation line of the property reference relation indicated by the user specification; and
displaying the selected property reference relation line on the screen on which the plurality of process icons and the execution order line are displayed.

4. The method according to claim 3,
wherein the user specification specifies a process icon, and
wherein the property reference relation indicated by the user specification comprises a property reference relation including a property of the specified process icon.

5. The method according to claim 1,
wherein the management system is configured to store information for managing properties of the plurality of processes, and
wherein the method, which is executed by the management system, further comprises:
searching, based on the information, for an output property of another process icon having the same property name and data type as a first input property of a first process icon, the another process icon being executed before the first process icon; and
displaying the property reference relation line between the output property found based on the search and the first input property.

6. The method according to claim 5, the method, which is executed by the management system, further comprising:
receiving user input of the execution order line from a second process icon to the first process icon; and
executing the search in response to reception of the user input of the execution order line.

7. The method according to claim 1, the method, which is executed by the management system, further comprising displaying, in each process icon of the plurality of process icons, a list of the input properties and the output properties of the each process icon,
wherein the property reference relation line connects properties of the lists in different process icons.

8. A management system configured to assist creation of an automatic execution service, the management system comprising:
a processor;
a display device; and
a memory,
the processor being configured to generate image data of an image showing a configuration of the automatic execution service,
the display device being configured to display the image based on the image data,
the image comprising:
a plurality of process icons of a plurality of processes included in the automatic execution service;
an execution order line, which connects the plurality of process icons and which indicates an execution order of the plurality of processes; and
a property reference relation line, which connects the plurality of process icons and which indicates a property reference relation between the plurality of processes.

9. The management system according to claim 8, wherein the property reference relation line comprises a curved line.

10. The management system according to claim 8, wherein the processor is configured to:
receive a user specification of the property reference relation;
select the property reference relation line of the property reference relation indicated by the user specification; and
include the selected property reference relation line in the image including the plurality of process icons and the execution order line.

11. The management system according to claim 10,
wherein the user specification specifies a process icon, and
wherein the property reference relation indicated by the user specification comprises a property reference relation including a property of the specified process icon.

12. The management system according to claim 8,
wherein the management system is configured to store information for managing properties of the plurality of processes,
wherein the processor is configured to:
search, based on the information, for an output property of another process icon having the same property name and data type as a first input property of a first process icon, the another process icon being executed before the first process icon; and
include, in the image, the property reference relation line between the output property found based on the search and the first input property.

13. The management system according to claim 12, wherein the processor is configured to:
receive user input of the execution order line from a second process icon to the first process icon; and
execute the search in response to reception of the user input of the execution order line.

14. The management system according to claim 8,
wherein the image comprises, in each process icon of the plurality of process icons, a list of the input properties and the output properties of the each process icon, and
wherein the property reference relation line connects properties of the lists in different process icons.
